(19) United States
(12) Patent Application Publication
(10) Pub. No.: US 2019/0042916 A1
(43) Pub. Date: Feb. 7, 2019

(54) Reward-Based Updating of Synaptic Weights with A Spiking Neural Network to Perform Thermal Management

(71) Applicant: Intel Corporation, Santa Clara, CA (US)

(72) Inventors: Yongqiang Cao, Portland, OR (US); Helin Cao, Portland, OR (US)

(21) Appl. No.: 16/147,573

(22) Filed: Sep. 28, 2018

(51) Int. Cl. G06N 3/04; G06N 3/08; G06F 1/20

(52) U.S. Cl. CPC G06N 3/049; G06F 1/206; G06N 3/08

(57) ABSTRACT

Thermal management of a computing device is achieved using reward-based updating of synaptic weights of a spiking neural network. The thermal management is achieved using machine readable mediums having instructions that cause a processor to, during a first time window, generate weights to be applied to input trains of spikes from input neurons of a spiking neural network. The instructions further cause the processor to, based on a number of spikes included in an output train of spikes output by an output neuron of the spiking neural network during the first time window, adjust the workload of the processor, and, based on whether a surface temperature of an enclosure housing the processor meets a first threshold or a workload of the processor meets a second threshold, generate a penalty. The instructions also cause the processor to train the spiking neural network by updating the weights.

### FIELD OF THE DISCLOSURE

This disclosure relates generally to neural networks, and more particularly, to reward-based updating of synaptic weights with a spiking neural network to perform thermal management.

### BACKGROUND

A variety of approaches are currently used to implement neural networks in computing systems. The implementation of such neural networks, commonly referred to as “artificial neural networks,” generally include a large number of highly interconnected processing elements that exhibit some behaviors similar to that of organic brains. Such processing elements may be implemented with specialized hardware, modeled in software, or a combination of both.

Spiking neural networks (or “SNNs”) are increasingly being adapted to provide next-generation solutions for various applications. SNNs rely on signaling techniques that communicate information using a time-based relationship between signal spikes. As compared to typical deep-learning architectures—such as those provided with a convolutional neural network (CNN) or a recurrent neural network (RNN)—a SNN provides an economy of communication which, in turn, allows for orders of magnitude improvement in power efficiency.

### BRIEF DESCRIPTION OF THE DRAWINGS

FIG. 1 shows diagrams illustrating features of a simplified neural network.

FIG. 2 is a flow diagram illustrating elements of a method to determine a value of a synaptic weight of a spiking neural network.

FIG. 3 shows a circuit diagram and a timing diagram illustrating elements of a signaling to determine a value of a synaptic weight.

FIG. 4 shows a state diagram and a functional block diagram illustrating features of a spiking neural network to perform a binary decision making process.

FIG. 5 shows timing diagrams illustrating results of a binary decision making process performed with a spiking neural network.

FIG. 6 is a block diagram of a computer system and example network edge computing devices that include an example thermal management system constructed in accordance with teachings of this disclosure.

FIG. 7 is a block diagram of an example implementation of the thermal management system of FIG. 6.

FIG. 8 is a block diagram of an example implementation of the thermal control agent of the thermal management system of FIG. 7.

FIG. 9 is a block diagram of an example implementation of the reward/penalty generator of the thermal management system of FIG. 7.

FIG. 10 is a block diagram of an example implementation of the detector logic of the thermal management system of FIG. 7.

FIG. 11 is a flowchart representative of example machine readable instructions which may be executed to implement the example thermal management system of FIG. 7.

FIG. 12 is a flowchart representative of example machine readable instructions which may be executed to implement the example thermal control agent of FIG. 7 and FIG. 8.

FIG. 13 is a flowchart representative of example machine readable instructions which may be executed to implement the example thermal control agent of FIG. 7 and FIG. 8.

FIG. 14 is a flowchart representative of example machine readable instructions which may be executed to implement the example thermal control agent of FIG. 7 and FIG. 8.

FIG. 15 is a flowchart representative of example machine readable instructions which may be executed to implement the example penalty/reward generator of FIG. 7 and FIG. 9.

FIG. 16 is a block diagram of an example processing platform structured to execute the instructions of FIGS. 11, 12, 13, 14 and/or 15 to implement the thermal management system of FIG. 7.

The figures are not to scale. In general, the same reference numbers will be used throughout the drawing(s) and accompanying written description to refer to the same or like parts.

### DETAILED DESCRIPTION

Neural networks are configured to implement features of “learning”, which generally are used to adjust the weights of respective connections between the processing elements that provide particular pathways within the neural network and processing outcomes. Existing approaches for implementing learning in neural networks have involved various aspects of unsupervised learning (e.g., techniques to infer a potential solution from unclassified training data, such as through clustering or anomaly detection), supervised learning (e.g., techniques to infer a potential solution from classified training data), and reinforcement learning (e.g., techniques to identify a potential solution based on maximizing a reward). However, each of these learning techniques are complex to implement, and extensive supervision or validation is often required to ensure the accuracy of the changes that are caused in the neural network.

During operation of the spiking neural network, such a weight assigned to a synapse of a spiking neural network (also referred to herein as a “synaptic weight value” or, for brevity, “weight value”) may be applied to a signal which is communicated via the synapse.

As used herein, “input node” refers to a node by which a signal is received at a spiking neural network. The term “output node” (or “readout node”) refers herein to a node by which a signal is communicated from a spiking neural network. The term “input signaling” refers herein to one or more signals (e.g., including one or more spike trains) which are received at a respective input node of a spiking neural network. The term “output signaling” refers herein to one or more signals (e.g., including one or more spike trains) which are communicated from a respective output node of a spiking neural network. The term “spiked input signals” is also used herein to refer to one or more input spike trains. “Spiked output signals,” as used herein, similarly refers to one or more output spike trains. The term “reward/penalty signal” refers herein to a signal which indicates, based on an evaluation of output signaling from a spiking neural network, whether some processing performed with the spiking neural network has, according to test criteria, been successful (or alternatively, unsuccessful). “Trace” refers herein to a variable (e.g., represented as a signal or stored data) which may change over time due, for example, to signal activity which is detected at a given node. The term “eligibility trace” refers more particularly to a trace which indicates a sensitivity of some value (e.g., that of some other trace or signal) to change in response to a different value (e.g., that of yet another trace or signal). For example, an eligibility trace may represent a susceptibility of a given trace, weight or such other parameter to being changed in response to another parameter. In some examples, such a sensitivity/susceptibility may be represented as a value which is equal to, or otherwise based on, a product of the respective values of the eligibility trace and the other parameter. However, any of a variety of other functions may be used to determine such a level of sensitivity/susceptibility.

In some examples, operation of a spiking neural network includes the communication of multiple spike trains via a respective synapse coupled between two corresponding network nodes (e.g., in response to input signaling received by the spiking neural network). Such communications may result in the spiking neural network providing output signaling which is to provide a basis for subsequent signaling which updates one or more synaptic weight values. For example, the output signaling may be evaluated to determine whether (or not) a satisfaction of some test criteria is indicated. Based on such evaluation, one or more reward/penalty signals may be communicated to and/or within the spiking neural network (e.g., wherein one such reward/penalty signal is provided to at least one node which participated in the earlier communication of various spike trains). Based on such reward/penalty signaling, one or more synaptic weight values of the spiking neural network may be updated.

A spiking neural network may be operable to facilitate the determining of a sequence of states (or “state sequence”) (e.g., the spiking neural network implements, at least in part, a finite state machine (FSM) which includes such states and multiple transitions from a respective current state to a respective next state). Successive evaluations, each for a corresponding processing stage performed with such a spiking neural network, may each detect whether processing performed to-date is successful (or unsuccessful), according to some test criteria. Based on the evaluations, successive rounds of synaptic weight updates may be performed (e.g., to facilitate training of the spiking neural network to identify an efficient state sequence that satisfies the test criteria).

The examples described herein may be implemented in one or more electronic devices. Non-limiting examples of such electronic devices include any kind of mobile device and/or stationary device, such as cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary. Other such example electronic devices include desktop computers, laptop computers, smart phones, tablet computers, netbook computers, notebook computers, personal digital assistants, server, combinations thereof, and the like. More generally, the examples described herein may be employed in any of a variety of electronic devices to update a synaptic weight value of a spiking neural network.

Examples disclosed herein further include thermal management methods, systems and apparatus that update a synaptic weight of a spiking neural network. Some such thermal management methods, systems and apparatus include a spiking neural network that employs synaptic weights that are updated based on at least two eligibility traces, a reward/penalty value, and a number of spikes generated at an output of the spiking neural network. Example thermal management methods, systems and apparatus disclosed herein have an extremely low power footprint and are able to learn without any prior knowledge of the system being managed.

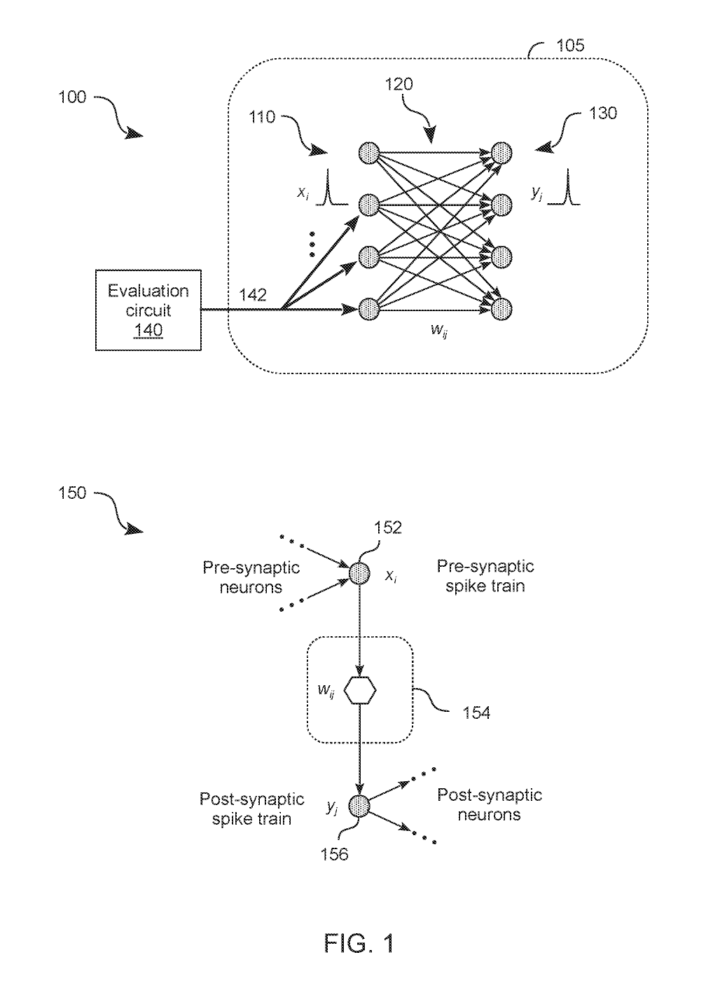

FIG. 1 illustrates an example diagram of a system 100 which includes a spiking neural network 105, providing an illustration of connections 120 between a first set of nodes 110 (e.g., neurons) and a second set of nodes 130 (e.g., neurons). Some or all of a neural network (such as the spiking neural network 105) may be organized into multiple layers (e.g., including input layers and output layers). The example spiking neural network 105 of FIG. 1 only depicts two layers and a small number of nodes, but other forms of neural networks may include a large number of nodes, layers, connections, and/or pathways.

Data that is provided into the neural network 105 may be first processed by synapses of input neurons. Interactions between the inputs, the neuron's synapses and the neuron itself govern whether an output is provided via an axon to another neuron's synapse. Modeling the synapses, neurons, axons, etc., may be accomplished in a variety of ways. For example, neuromorphic hardware includes individual processing elements in a synthetic neuron (e.g., neurocore) and a messaging fabric to communicate outputs to other neurons. The determination of whether a particular neuron “fires” to provide data to a further connected neuron is dependent on the activation function applied by the neuron and the weight of the synaptic connection (e.g., wᵢⱼ) from neuron i (e.g., located in a layer of the first set of nodes 110) to neuron j (e.g., located in a layer of the second set of nodes 130). The input received by neuron i is depicted as value xᵢ, and the output produced from neuron j is depicted as value yⱼ. Thus, the processing conducted in a neural network is based on weighted connections, thresholds, and evaluations performed among the neurons, synapses, and/or other elements of the neural network.

In some examples, the neural network 105 is established from a network of spiking neural network cores, with the neural network cores communicating via short packetized spike messages sent from core to core. For example, a neural network core may implement some number of primitive nonlinear temporal computing elements as neurons, so that when a neuron's activation exceeds some threshold level, it generates a spike message that is propagated to a fixed set of fanout neurons contained in destination cores. The network may distribute the spike messages to the destination neurons, and in response those neurons update their activations in a transient, time-dependent manner, similar to the operation of real biological neurons.

The neural network 105 further shows the receipt of a spike, represented in the value xᵢ, at neuron i in a first set of neurons (e.g., a neuron of the first set of nodes 110). The output of the neural network 105 is also shown as a spike, represented by the value y ⱼ, which arrives at neuron j in a second set of neurons (e.g., a neuron of the first set of nodes 110) via a path established by the connections 120. In a spiking neural network communication occurs over event-driven action potentials, or spikes. In some examples, spikes convey no information other than the spike time as well as a source and destination neuron pair. Computations may occur in one or more respective neurons as a result of the dynamic, nonlinear integration of weighted spike input using real-valued state variables. The temporal sequence of spikes generated by or for a particular neuron may be referred to as its “spike train.”

In some examples of spiking neural networks, activation functions occur via spike trains. As such, time is a factor that has to be considered. Further, in a spiking neural network, one or more of the neurons may provide functionality similar to that of a biological neuron, as the artificial neuron receives its inputs via synaptic connections to one or more “dendrites” (part of the physical structure of a biological neuron), and the inputs affect an internal membrane potential of the artificial neuron “soma” (cell body). In some spiking neural network examples, the artificial neuron “fires” (e.g., produces an output spike), when its membrane potential crosses a firing threshold. Thus, the effect of inputs on a spiking neural network neuron operate to increase or decrease its internal membrane potential, making the neuron more or less likely to fire. Further, in a spiking neural network, input connections may be stimulatory or inhibitory. A neuron's membrane potential may also be affected by changes in the neuron's own internal state (“leakage”).

In some examples, a synaptic weight value is updated based on a reward/penalty signal which is provided to a spiking neural network. The reward/penalty signal of some such examples is based on an evaluation of an earlier output signaling by the spiking neural network. For example, system 100 may further include or couple to hardware (such as the illustrative evaluation circuit 140 shown) and/or software which is coupled to receive output signaling such as that represented by the illustrative value yⱼ. Evaluation circuit 140 may include one or more of any of a processor, an application specific integrated circuit (ASIC), a field programmable gate array (FPGA) and/or other circuitry to evaluate such output signaling (e.g., based on some test criteria) to determine whether the output signaling is indicative of successful (or unsuccessful) processing by the spiking neural network 105. A result of such evaluation may be communicated to some or all nodes of the spiking neural network 105 (e.g., via the illustrative reward/penalty signal 142 shown). In some examples, reward/penalty signal 142 is a spiking pattern which is communicated via synapses which are used in the generation of value yⱼ. Alternatively or in addition, one or more sideband signal paths may be dedicated to the communication of reward/penalty information such as that of reward/penalty signal 142.

FIG. 1 also illustrates an example inference path 150 in a spiking neural network, such as may be implemented by the neural network 105 and/or one or more other neural networks. The inference path 150 of the neuron includes a pre-synaptic neuron 152, which produces a pre-synaptic spike train xᵢ representing a spike input. As used herein, a spike train is defined to be a temporal sequence of discrete spike events, which provides a set of times specifying at which time a neuron fires.

As shown, the spike train xᵢ is produced by the neuron before the synapse (e.g., neuron 152), and the spike train xᵢ is evaluated for processing according to the characteristics of a synapse 154. For example, the synapse may apply one or more weights, (e.g., weight wⱼⱼ) which are used in evaluating the data from the spike train xᵢ. Input spikes from the spike train xᵢ enter a synapse such as synapse 154 which has a weight wⱼⱼ. This weight scales what the impact of the presynaptic spike has on the post-synaptic neuron (e.g., neuron 156). If the integral contribution (e.g., the sum) of all input connections to a post-synaptic neuron exceeds a threshold, then the post-synaptic neuron 156 will fire and produce a spike. As shown, yⱼ is the post-synaptic spike train produced by the neuron following the synapse (e.g., neuron 156) in response to some number of input connections. As shown, the post-synaptic spike train yⱼ is distributed from the neuron 156 to other post-synaptic neurons.

In some examples, nodes of the spiking neural network 105 are of a Leaky Integrate-and-Fire (LIF) type (e.g., based on one or more spiking signals received at a given node j, the value of a membrane potential vₘ of that node j may spike and then decay over time). The spike and decay behavior of such a membrane potential vₘ may, for example, be according to the following equation:

$${τ}_{m} ( \frac{{dv}_{m}}{dt} ) ∝ - ( {v}_{m} - {v}_{rest} ) + {w}_{ij} \cdot {I}_{ij} + {J}_{b} , \qquad Eq ( 1 )$$

where vᵣₑₛₜ is a resting potential toward which the membrane potential vₘ is to settle, τₘ is a time constant for an exponential decay of membrane potential vₘ, wᵢⱼ is a synaptic weight of a synapse from another node i to node j, Iᵢⱼ is a spiking signal (or “spike train”) communicated to node j via said synapse, and J_{b} is a value that, for example, is based on a bias current or other signal provided to node j from some external node/source. The spiking neural network 105 may operate based on a threshold voltage V_{threshold}. In some such examples, the node j is configured to output a signal spike in response to its membrane potential vₘ being greater than V_{threshold}.

Certain features of are described herein with reference to determining the value of a weight which is assigned to a synapse coupled directly to two nodes (e.g., node i and node j), and is to provide communication of a spike train from node i to node j. The notation “i” indicates an association with node i, and the notation “j” indicates association with node j. For example, node i may maintain a trace Xᵢ which is to provide a basis for determining (e.g., which is to equal) a spike train communicated from node i to node j via the synapse (which has a weight wᵢⱼ). Trace Xᵢ may be based in part on a signal Sᵢ which is received by node i (e.g., via a different synapse from a node other than node j). In such an example, node j may maintain a trace Yⱼ which is to equal, or is otherwise to provide a basis for determining, another spike train communicated from node j (e.g., to a node other than node i). The trace Yⱼ may be based in part on trace Xᵢ (e.g., the trace Yⱼ is based on the spiked signal which is received from node i via the synapse).

In some examples, the value of the synaptic weight wᵢⱼ may be determined based in part on a signal (referred to herein as a “reward/penalty signal”) which is provided to the spiking neural network based on an output from the spiking neural network. For example, an evaluation of such an output may determine whether (or not) some test criteria is satisfied. Based on the evaluation, a reward/penalty signal may be communicated to one or more nodes (e.g., including node j) of the spiking neural network. In response to an assertion of the reward/penalty signal, the one or more nodes may each perform a respective process to update a corresponding weight value.

For example, two traces Yⱼ₀, Yⱼ₁ may be maintained (at node j, for example) for use in determining whether and/or how weight wᵢⱼ is to be updated. Trace Yⱼ₀ may indicate, based, at least in part, on trace Xᵢ, a level of recent signal spiking activity at the node j (e.g., spiking by trace Xᵢ is equal to, or is otherwise a basis for, spiking by the spike train which node i communicates to node j via the synapse). Similarly, spiking by trace Yⱼ₀ may be equal to, or otherwise provide a basis for, spiking by another spike train which node j communicates via a different synapse (e.g., to a node other than node i). More particularly, Yⱼ₀ may be the spiking of a post-synaptic neuron, such as post-synaptic spike train yⱼ in FIG. 1.

One or both of the traces Xᵢ, Yⱼ₀ may exhibit respective spike-and-decay signal characteristics. For example, a spike of trace Xᵢ, based on a spike of signal Sᵢ, may decay over time until some next spike of signal Sᵢ. Alternatively or in addition, a spike of trace Yⱼ₀, based on a spike of trace Xᵢ, may decay over time until some next spike of trace Xᵢ. One or more other traces described herein may similarly exhibit respective spike-and-decay signal characteristics.

In such an example, trace Yⱼ₁ may be based on both trace Yⱼ₀ and a reward/penalty signal R. Trace Yⱼ₁ may indicate a level of correlation between a spiking pattern of trace Yⱼ₀ and an assertion of the reward/penalty signal R. The reward/penalty signal R indicates a result of an evaluation which is performed based on output signaling by the spiking neural network. For example, the reward/penalty signal R may indicate whether, according to some test criteria, processing performed with the spiking neural network has been a success (or alternatively, a failure). Spiking by trace Yⱼ₁ may be based on a type of sequence which includes one or more signal spikes of trace Yⱼ₀ and one or more signal spikes of reward/penalty signal R. For example, node j may be configured to generate (or alternatively, prevent) signal spiking by trace Yⱼ₁ in response to detecting that a particular type of signal spiking by reward/penalty signal R is within some time window after a particular type of signal spiking by trace Yⱼ₀. Alternatively or in addition, node j may be configured to generate (or alternatively, prevent) some other signal spiking by trace Yⱼ₁ in response to detecting that a particular type of signal spiking by reward/penalty signal R has not occurred within such a time window. Node j may be configured to additionally or alternatively generate (or prevent) such other signal spiking by trace Yⱼ₁ in response to detecting that the particular type of signal spiking by reward/penalty signal R has occurred in the absence of any corresponding type of signal spiking by trace Yⱼ₀.

In such an example, an update to weight w may be based on trace Yⱼ₁. For example, the value of the weight wᵢⱼ is increased based on a corresponding change to Yⱼ₁ (where the change to Yⱼ₁ is due to an indication by the reward/penalty signal R of successful processing with the spiking neural network). Alternatively or in addition, the value of weight wᵢⱼ may be decreased based on a change to Yⱼ₁ which, in turn, is due to an indication by reward/penalty signal R of unsuccessful processing with the spiking neural network. In some examples, the weight wᵢⱼ does not exhibit signal decay, but may instead maintain a given value/level until a subsequent change to Yⱼ₁ results in the value of the weight w being increased or decreased.

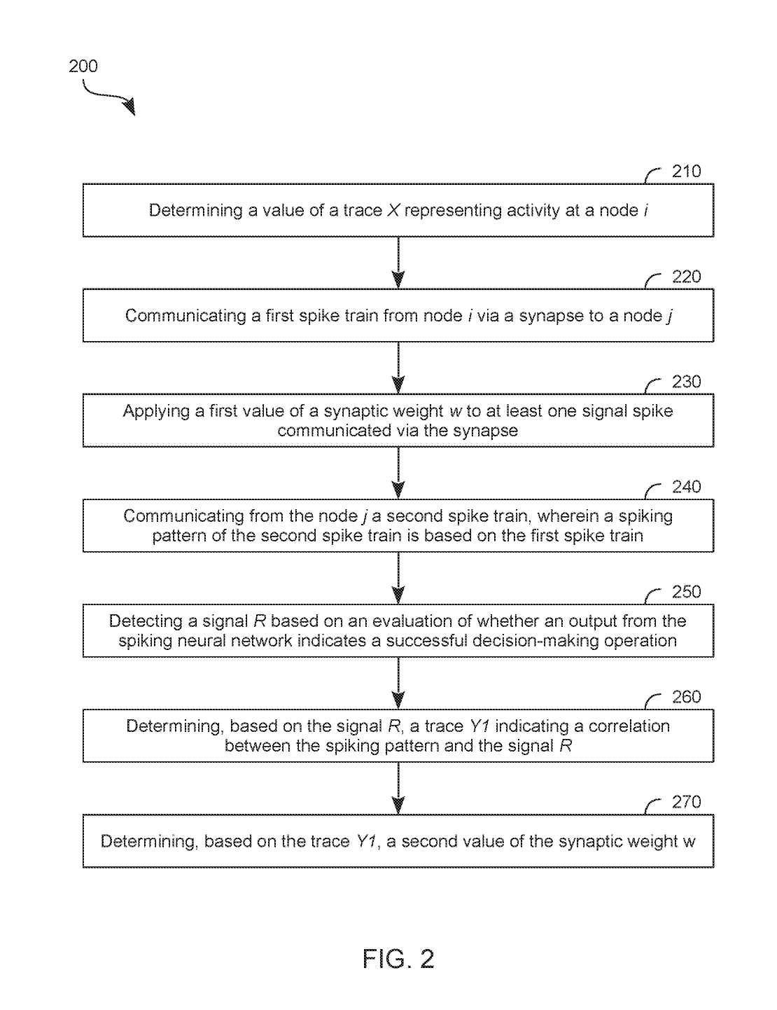

FIG. 2 shows features of a method 200 to operate a spiking neural network In the example method 200, reward/penalty signaling is provided to update one or more synaptic weight values. For example, the spiking neural network is configured to determine any of various state transitions of a state machine. The method 200 may be performed with neural network 105, for example.

As shown in FIG. 2, the method 200 may include (at block 210) determining a value of a trace X (e.g., the trace X, described elsewhere herein) which indicates a level of recent activity at a node i of a spiking neural network. The value of trace X may be determined at block 210, for example, based at least in part on a spike train (such as signal Sᵢ) which is received at node i. The method block 200 may further include (at block 220) communicating a first spike train from the node i to a node j of the spiking neural network via a synapse coupled therebetween. Spiking of the first spike train may be the same as, or otherwise based upon, spiking of trace X.

In some examples, the method further includes (at block 230) applying a first value of a synaptic weight w to at least one signal spike communicated via the synapse, the first value based on trace X. For example, the applying at block 230 may include signal processing logic of node j amplifying the first spike train or otherwise multiplying a value which represents the first spike signal at least in part. The method 200 may further include (at block 240) communicating, from the node j, a second spike train. A spiking pattern of the second spike train is based on the first spike train. The second spike train may include or otherwise result in output signaling which is to be provided from the spiking neural network.

In some examples, the method 200 further includes (at block 250) detecting a signal R provided to the spiking neural network, where the signal R (e.g., a reward/penalty signal) is based on an evaluation of whether, according to some criteria, an output from the spiking neural network indicates a successful decision-making operation. For example, the spiking neural network may be trained or otherwise configured to implement any of multiple state transitions of a state machine. Such a spiking neural network may receive input signaling which indicates a given state of a sequence of state transitions. In response to such input signaling, one or more nodes of the spiking neural network may communicate spike trains via a respective synapse. Such spike train communications may result in output signaling, from the spiking neural network, which indicates a decision which selects a state of the state machine that is to be a next successive state of the state sequence. Based on such output signaling, circuitry coupled to the spiking neural network may evaluate whether the decision has resulted in a violation of some test criteria by the state sequence and/or the satisfaction of some other test criteria by the state sequence.

The method 200 further includes (at block 260) determining, based on the signal R, a value of a trace Y1 which indicates a level of correlation between the spiking pattern and the signal R. Such correlation may be indicated by a proximity in time of spiking by the second spike train and associate spiking by signal R. For example, determining the value of trace Y1 at block 260 may include detecting that a spiking pattern of the second spike train is followed, within a time window, by a corresponding spiking pattern of the signal R. In some examples, a spike of trace Y1 is in response to a spike of the second spike train (and/or a spike of a trace on which the second spike train is based) being followed, within the time window, by a spike of the signal R.

The method 200 may further include (at block 270) determining, based on trace Y1, a second value of the synaptic weight w. For example, output signaling from the spiking neural network may include a first spiking pattern which corresponds to a first decision-making operation of a sequence of decision-making operations with the spiking neural network. In such an example, spiking by signal R, based on an evaluation of the first spiking pattern, may alter trace Y1, resulting in a first change (e.g., a decrease) of synaptic weight w to a first value. In such an example, the output from the spiking neural network may further include a second spiking pattern which corresponds to a second decision-making operation of the sequence of decision-making operations. In such an example, subsequent spiking by signal R, based on an evaluation of the second spiking pattern, may again alter trace Y1, resulting in a second change (e.g., an increase) of synaptic weight w from the first value.

In some examples, the method 200 further includes determining a value of a trace r which indicates a level of recent activity by the signal R. Node j may be configured, for example, to provide a spike of tracer in response to a spike of the signal R (e.g., the spike of trace r decays over time). For example, trace r may increase in response to signal R indicating a reward for successful processing by the spiking neural network. Alternatively or in addition, trace r may decrease in response to signal R indicating a penalty for unsuccessful processing by the spiking neural network. In such examples, determining the second value of synaptic weight w may be further based on trace r. For example, determining the value of trace Y1 at 260 based on the signal R may include detecting that a spiking pattern of the second spike train is followed, within a time window, by a corresponding spiking pattern of the signal R. The spike of the tracer (e.g., in combination with an associated spike in trace Y1) may result in a change to the value of the weight w.

In some examples, determining the second value, at 270, based on trace Y1 includes determining the second value based on another trace E1 (e.g., an eligibility trace) which, itself, is based on trace Y1. The value of such a trace E1 may indicate a level of susceptibility of synaptic weight w to being changed based on signal R. For example, traces E1, Y1 may correspond (respectively) to traces Eₐ, Yⱼ₁ in functional relationships f₂, f₃, f₄ which are shown in equations (2) through (4) as:

Eₐ=f₂{Yⱼ₁} Eq(2)

r=f₃{R} Eq(3)

wᵢⱼ=f₄{Eₐ, r} Eq(4)

In such examples, trace Eₐ may indicate a level of susceptibility of synaptic weight w to being changed based on the indication (by trace r, for example) that signal R as signaled a particular reward/penalty event. Trace Eₐ may exhibit spike-and-decay signal characteristics (e.g., a spike of trace E_{a is} based on a particular one or more signal spikes of trace Yⱼ₁).

In some examples, such an eligibility trace Eₐ is one of two or more eligibility traces which are each used to determine the value of a weight wᵢⱼ, wherein at least one of the two or more eligibility traces is based on a value (such as that of trace Yⱼ₁) which indicates a level of correlation between signal spiking by node j and an assertion of a reward/penalty signal R. For example, the method 200 further includes determining a value of a trace E0 which indicates a level of correlation between the recent activity at the node i and the recent activity at the node j. A spike of trace E1 is in response to respective spikes of the trace E0 and the trace Y1. In such examples, the trace E0 may indicate a level of susceptibility of the trace E1 to being changed based on the trace Y1.

For example, node j be trained or otherwise configured to maintain respective values of trace E0 and another trace Y0 (e.g., the trace Yⱼ referred to elsewhere) which indicates a level of recent activity at the node j. In such an example, node j may provide a spike of trace E0 in response to respective spikes of trace X and trace Y0. Traces E0, E1, Y0, and Y1 may correspond, for example, to traces Eᵢⱼ¹, Eᵢⱼ², Yⱼ₀, and Yⱼ₁ (respectively) in functional relationships f₅ through f₈ which are shown in equations (5) through (8) as:

Eᵢⱼ¹=f₅{Xᵢ, Yⱼ₀} Eq(5)

Eᵢⱼ²=f₆{Eᵢⱼ¹, Yⱼ₁} Eq(6)

r=f₇{R} Eq(7)

wᵢⱼ=f₈{Eᵢⱼ², r} Eq(8)

In some such examples, a sensitivity of weight wᵢⱼ to change based on trace r may be based on value which is, in turn, is based on a product of the respective values of traces r, Eᵢⱼ². Alternatively or in addition, a sensitivity of trace Eᵢⱼ² to change based on trace Yⱼ₁ may be based on value which is, in turn, is based on a product of the respective values of traces Yⱼ₁, Eᵢⱼ¹. However, any of a variety of additional or alternative functions may be used each to determine the sensitivity of a respective parameter to change, according to an associated eligibility trace, in response to change by another respective parameter.

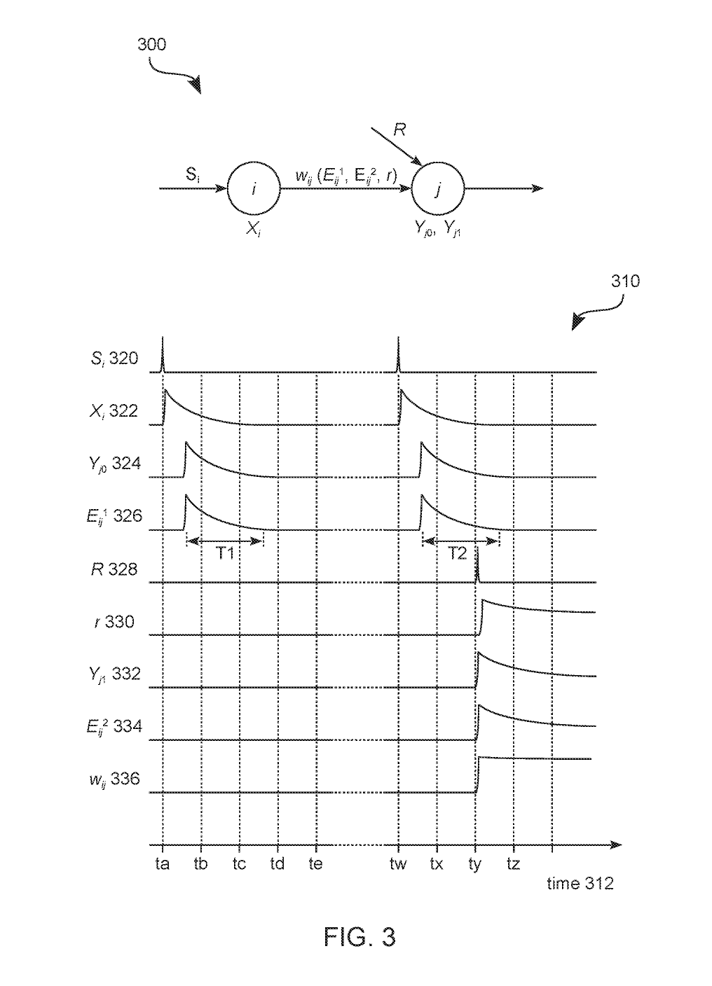

FIG. 3 shows a circuit 300 of a spiking neural network which is configured to update a synaptic weight value based on a reward/penalty signal according to an example. FIG. 3 also shows a timing diagram 310 which illustrates, each with respect to a time axis 312, various plots each for a different respective trace, signal or weight which is determined with circuit 300. Parameters such as some or all of those shown in timing diagram 310 may be determined according to the method 200 (e.g., operations of the method 200 are performed with spiking neural network 105).

As shown in FIG. 3, circuit 300 includes nodes i, j and a synapse coupled therebetween, wherein a weight wᵢⱼ is assigned to the synapse. Timing diagram 310 shows respective plots 320, 322, 324, 326, 330, 332, 334 of spike train Sᵢ, and traces Xᵢ, Yⱼ₀, E¹ᵢⱼ, r, Yⱼ₁, and E²ᵢⱼ used to determine a value of synaptic weight wᵢⱼ. Timing diagram 310 also shows respective plots 328, 336 of a reward/penalty signal R and weight wᵢⱼ. To avoid obscuring certain features of various examples, the respective scales of plots shown in timing diagram 310 are normalized to unitless values in magnitude and time. Such scales may vary widely according to implementation-specific details, which are not limiting on some examples.

In the example shown, the trace Xᵢ represents signaling activity at node i (e.g., the signaling includes a pre-synaptic spike train Sᵢ communicated via another synapse). The trace Yⱼ₀ represents signaling activity at node j, includes a spike train, based on trace Xᵢ, which node j receives from node i via the synapse. Eligibility trace Eᵢⱼ¹ is indicative of a temporal proximity of spiking (e.g., including one or more signal spikes) by trace Xᵢ, to spiking by trace Yⱼ₀. For example, a level/value of trace Eᵢⱼ¹ may spike (and in some examples, subsequently decay) based on a proximity in time between a signal spike of the trace Xᵢ (or of a spike train otherwise based on trace Xᵢ) and a subsequent signal spike of the trace Yⱼ₀. The proximity in time may need to be within some threshold maximum time duration, for example.

Reward/penalty signal R, provided to the spiking neural network, may be based on an evaluation (based on some test criteria) of earlier output signaling from the spiking neural network. Trace r, maintained at node j, for example, indicates a recency of signal spiking by reward/penalty signal R (e.g., a level/value of the trace r spikes (and in some examples, subsequently decays) in response to a spike of the reward/penalty signal R). The trace Yⱼ₁ indicates a correlation of spiking activity by the trace Yⱼ₀ with spiking activity by the reward/penalty signal R. The eligibility trace E²ᵢⱼ is indicative of a concurrency or other temporal proximity of spiking by the trace Yⱼ₁ with spiking by the eligibility trace Eᵢⱼ¹.

Parameters, which are shown in timing diagram 310, may have functional relationships f₉ through f₁₃ which are illustrated in equations (9) through (13) as follows:

Xᵢ=Xᵢ^{old}·e^{-(t}^{ₓ}^{/τ}^{ₓ}⁾+Sᵢ Eq(9)

Eᵢⱼ¹=Eᵢⱼ¹^{_}^{old}·e^{-(t}^{ₑ₁}^{/τ}^{ₑ₁}⁾+XᵢYⱼ₀ Eq(10)

Eᵢⱼ²=Eᵢⱼ²^{_}^{old}·e^{-(t}^{ₑ₂}^{/τ}^{ₑ₂}⁾+BEᵢⱼ¹Yⱼ₁ Eq(11)

r=r^{old}·e^{-(t}^{ᵣ}^{/τ}^{ᵣ}⁾+R Eq(12)

wᵢⱼ=wᵢⱼ^{old}+Eᵢⱼ²*r Eq(13)

As shown in equations (9) through (13), the trace Xᵢ may decay over a length of time G since an earlier value Xᵢ^{old} of the trace Xᵢ (e.g., the trace Eᵢⱼ¹ is to decay over a length of time tₑ₁ since an earlier value Eᵢⱼ¹^{_}^{old} of trace Eᵢⱼ¹). Alternatively, or in addition, the trace Eᵢⱼ² may decay over a length of time tₑ₂ since an earlier value Eᵢⱼ²^{_}^{old} of the trace Eᵢⱼ² (e.g., the trace r may decay over a length of time tᵣ since an earlier value r^{old} of the trace r). The rates of decay by the traces Xᵢ, Eᵢⱼ¹, Eᵢⱼ², and r may be based on respective time parameters τₓ, τₑ₁, τₑ₂, and τᵣ, for example.

In some examples, multiple processing stages are performed with the spiking neural network which includes circuit 300. In some such examples the processing stages include or are followed by evaluation stages to determine whether successful (or unsuccessful) processing is indicated by respective output signaling from the spiking neural network.

The first time period [ta-te] shown on the time axis 312 may correspond to a result of a first processing stage and a second time period [tw-tz] corresponds to a result of a second processing stage. During the first time period [ta-te], spiking by the spike train Sᵢ may (for example) result in a spike by the trace Xᵢ which, in turn, contributes to a spike by the trace Yⱼ₀. As a result, a spike by the eligibility trace Eᵢⱼ¹ may be provided at the node j to indicate a proximity in time between the respective spiking of the traces Xᵢ, Yⱼ₀. Such spiking by the eligibility trace Eᵢⱼ¹ may increase a sensitivity of the trace Eᵢⱼ¹ to change in response to spiking that might take place with the trace Yⱼ₁. In some examples, any such spiking is limited to some time window, T1. In some examples, no such spiking by the trace Yⱼ₁ takes place during the time window T1, and a subsequent decay of the eligibility trace Eᵢⱼ¹ again decreases the sensitivity of the trace Eᵢⱼ¹ to change based on the trace Yⱼ₁.

During the second time period [tw-tz], further spiking by the spike train Sᵢ may again result in spiking by the trace Xᵢ and, in turn, another spike by the trace Yⱼ₀. As during the first time period [ta-te], a proximity in time between the respective spiking of traces Xᵢ, Yⱼ₀ may result in a spike by the eligibility trace Eᵢⱼ¹. However, whereas the first processing stage did not result in any reward event being indicated by reward/penalty signal R (and thus no spiking by spiking by trace Yⱼ₁ during time window T1), the second processing stage may result in spiking by reward/penalty signal R within a threshold maximum time window T2. In response, respective spikes by the trace r and the trace Yⱼ₁ may be asserted (e.g., due to spiking by the trace Yⱼ₀ being sufficiently correlated with the spike by reward/penalty signal R). Based on a temporal proximity of respective spiking by the trace Yⱼ₁ and the eligibility trace Eᵢⱼ¹ with each other, a spike may be provided by the eligibility trace Eᵢⱼ². Furthermore, a value of the weight wᵢⱼ may change (in this example, increase) based on a temporal proximity of the spiking by the trace Eᵢⱼ² with the spiking by the trace r.

A spiking neural network according to some examples may be operable to facilitate the determining of a sequence of states (or “state sequence”). In some such examples, the spiking neural network implements, at least in part, a finite state machine (FSM) which includes such states and multiple transitions each from a respective current state to a respective next state. The sequence of states may satisfy some criteria and, in some examples, may be relatively efficient, as compared to one or more alternative state sequences.

In some examples, a spiking neural network may be coupled to receive input signaling which specifies or otherwise indicates a given “current” state of the FSM. Such a spiking neural network may be trained or otherwise configured to generate output signaling, based on the received input signaling, which specifies or otherwise indicates an immediately successive “next” state of the state sequence which is to be determined. The spiking neural network may be configured, for example, to selectively indicate any one of the possible one or more states which, according to the FSM, is/are available to be the next state immediately succeeding the indicated current state. By way of illustration and not limitation, the spiking neural network may pseudo-randomly indicate one (and only one) such possible next state with the output signaling. However, in response to that same current state being indicated by other input signaling at a later time, the spiking neural network may provide output signaling which instead indicates a different one of the possible next states.

For example, the spiking neural network may be used to successively perform multiple processing stages which are each to determine, based on a respective current state of a sequence of states, a respective next stage of that sequence of states. For one such processing stage of the multiple processing stages, corresponding output signaling may indicate a respective next state which is to be indicated—by subsequent input signaling of a next successive processing stage of the multiple processing stages—as being the respective current state for that next successive processing stage. The multiple processing stages may thus successively determine respective states to be included in a given sequence of states.

In such an example, a set of one or more decision-making rules may be applied to determine whether (or not) a state sequence—or at least a portion of the state sequence that has been identified to-date—satisfies some test criteria for classifying a state sequence as being successful (or alternatively, unsuccessful). The test criteria may include one or more rules each associated with a respective one or more states. A given rule of such test criteria may specify that any state sequence must include (or alternatively, must omit) a particular one or more states (e.g., the state sequence must include (or omit) at least one instance of a particular “sub-sequence” of states). For example, a rule may identify a given state (or sub-sequence of states) as being a “penalty” state (or sub-sequence) which results in a state sequence being identified as unsuccessful. Alternatively or in addition, a rule may identify a given state (or sub-sequence of states) as being a “reward” state (or sub-sequence) which may result in, or allow for, the state sequence being identified as successful (subject to the inclusion of any state/sub-sequence which is required to be in the sequence and/or the omission of any state/sub-sequence which is prohibited). In some examples, test criteria may identify one or more states as being available to serve as an “initialization” state, and may require that the state sequence begin at one such initialization state. Similarly, the test criteria may identify one or more states each as being available to serve as a “completion” state which is to end the state sequence. In some such examples, any transitioning to such a completion state will complete the determining of the state sequence.

Determining a sequence of state transitions of a FSM is just one example of an application, according to an example, wherein a reward/penalty signal may be provided, based on output signaling from a spiking neural network, to update one or more synaptic weight values. The updating of such synaptic weight values may result in the spiking neural network learning to generate state sequences which are more efficient (as compared to previously-determined state sequences) and/or more likely to be identified as successful. However, any of a variety of other reward/penalty signals may be provided, in other examples, to update a synaptic weight value of a spiking neural network.

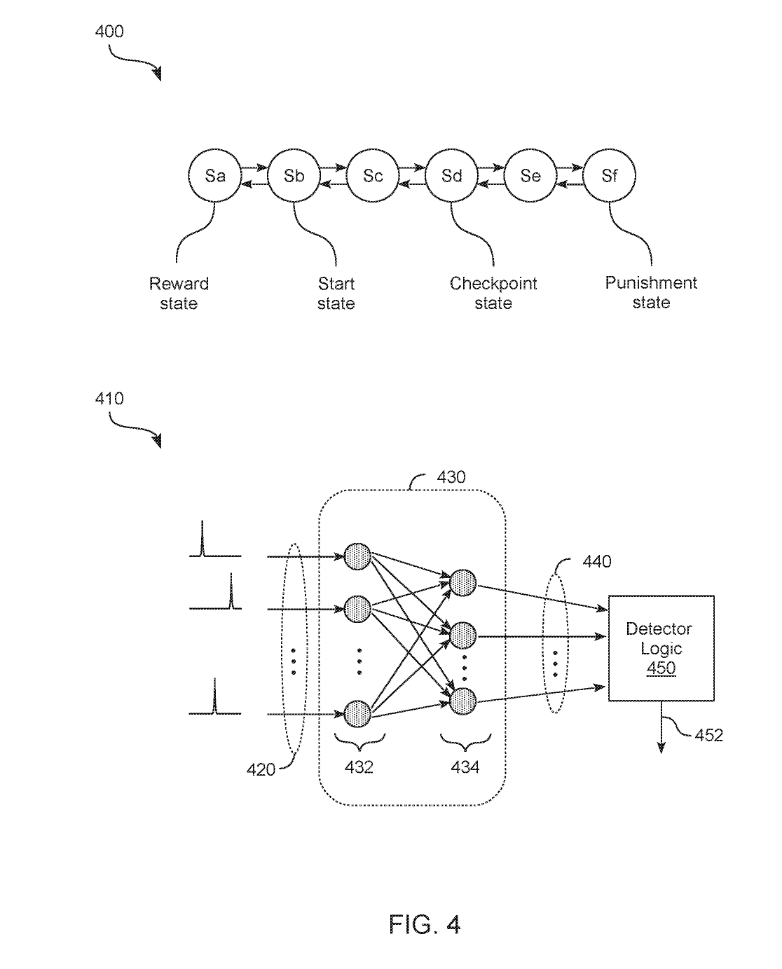

FIG. 4 shows features of a system 410 which is configured, according to an example, to determine a state transition of a state machine. System 410 is one example of an example wherein a synaptic weight value may be updated based on successful (or alternatively, unsuccessful) processing being indicated by output signaling from a spiking neural network. Such synaptic weight updating may be performed according to the method 200 (e.g., by the spiking neural network 430 of the system 410 which includes features of the spiking neural network 105).

Spiking neural network 430 includes input nodes 432 and output nodes 434, wherein synapses (and other nodes, in some examples) are variously coupled between input nodes 432 and output nodes 434. The particular number and configuration of the nodes and synapses shown for spiking neural network 430 are merely illustrative, and may instead provide any of a variety of other network topologies, in other examples. One or more spike trains 420 may be provided to a respective one of input nodes 432 (e.g., one or more spike trains 420 specify or otherwise indicate a current state of a state sequence that is to be determined with the spiking neural network 430). By way of illustration and not limitation, one or more spike trains 420 may indicate a sub-sequence of a most recent two (or more) states of the state sequence (e.g., the most recent two (or more) states includes a current state which is to be followed by an as-yet-undetermined next state of the state sequence). In such an example, spiking neural network 430 may be trained to determine a next state of a sequence of states according to a finite state machine (such as the illustrative state machine 400 shown). Based on such training, processing of the one or more spike trains 420 by spiking neural network 430 may result in output signaling (e.g., including a spike train of the one or more output spike trains 440 shown) that indicates a particular state of the state machine which is to be the next state of the state sequence.

In some examples, state machine 400 includes multiple states Sa, Sb, Sc, Sd, Se, Sf and various possible state transitions each between a respective two of such states. A set of one or more decision-making rules may define criteria according to which a given sequence—including various ones of states Sa, Sb, Sc, Sd, Se, Sf—is to be considered successful or unsuccessful. In combination with state machine 400, such test criteria may provide, at least in part, a model to be applied in any of a variety of system analysis problems related, for example, to logistics, computer networking, software emulation, and other such applications. Some examples are not limited to a particular type of application, system analysis problem, etc. for which spiking neural network 430 has been trained to provide a corresponding model.

In the example illustrated by state machine 400, test criteria for identifying a successful sequence or an unsuccessful sequence (corresponding to a reward event/signal and a penalty event/signal, respectively) includes a requirement that the sequence state at state Sa and a requirement that the sequence include state Sd. Furthermore, the test criteria identifies state Sa as being a reward state, wherein inclusion of the state Sa in the sequence enables (e.g., contingent upon the sequence having also included an instance of the required “checkpoint” state Sd) the communication of a reward signal to the spiking neural network 430. Further still, the test criteria identifies a state Sf as being a punishment state, wherein inclusion of the state Sf in the sequence requires the communication of a penalty signal to the spiking neural network 430.

The output signaling, provided by spiking neural network 440 based on input signaling 420, may be received by the detector logic 450 of the system 410 (e.g., the detector logic 450 corresponds functionally to evaluation circuit 140). Based on such output signaling, detector logic 450 may determine a state of state machine 400 which spiking neural network 430 has chosen to append as a next state of the state sequence being determined.

Detector logic 450 may evaluate whether the state sequence, as determined to-date, satisfies (or violates) any test criteria for classifying the sequence as successful (of unsuccessful) of the sequence. Based on a result of such evaluation, detector logic 450 may communicate to spiking neural network 430 a reward/penalty signal 452 (e.g., the signal R described elsewhere herein) which indicates one of a reward event and a penalty event. One or more synaptic weights of spiking neural network 430 may be updated based on the indicating of such a reward event or penalty event with an assertion of reward/penalty signal 452.

When the state sequence, as determined to-date, has been identified as successful (or alternatively, as unsuccessful), the state sequence may be considered complete As a result, the spiking neural network 430 is used in a next set of processing stages to attempt to determine a new state sequence which satisfies the test criteria. When the state sequence, as determined to-date, has not been identified as an unsuccessful, another processing stage may be performed with the spiking neural network 430 to determine yet another subsequent state to append to the state sequence. For example, the most recently determined next state of the sequence may be represented by a next round of input signaling 420 as the current state of a most recent two (or more) states. Detector logic 450 may then receive and evaluate later output signaling from spiking neural network 430 to identify a next state of the state sequence. The incrementally longer state sequence may then be evaluated by spiking neural network 430 to detect whether, according to the test criteria, a reward event or a penalty event is to be indicated to spiking neural network 430 using signal 452. Such an evaluation may result in additional adjusting of one or more network nodes (e.g., the spiking neural network 430 learns to improve its selection of a next state).

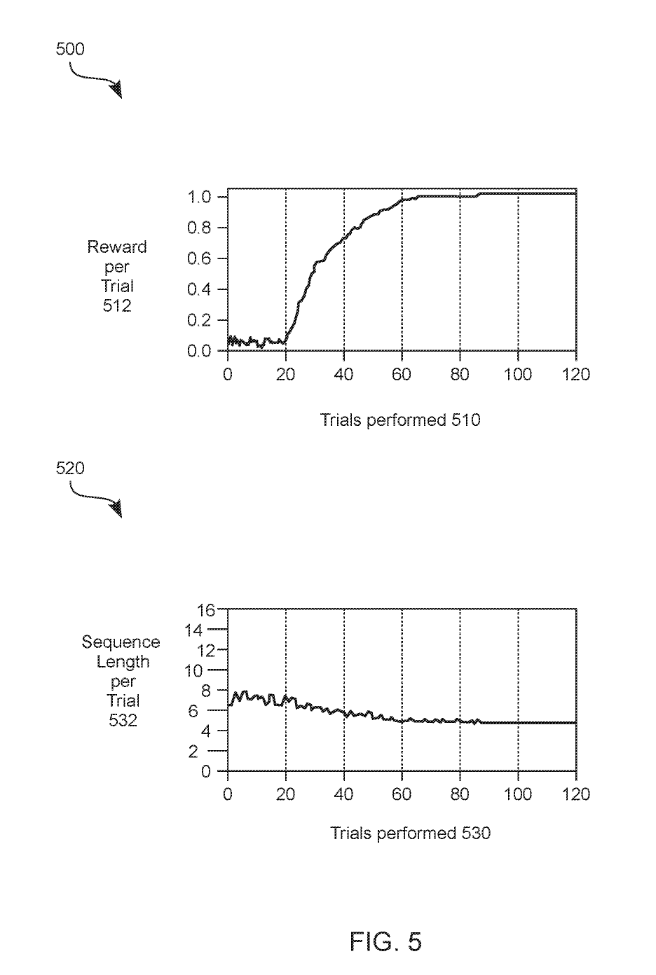

FIG. 5 shows graphs 500, 520 illustrating respective performance metrics for a binary decision-making process with a spiking neural network according to an example. Graphs 500, 520 represent the efficiency of multiple processing stages which are performed with a spiking neural network, according to one example, to identify a sequence of states of state machine 400.

More particularly, graph 500 shows a domain axis 510 representing multiple trials, in the order they were performed, which are each an attempt to determine a corresponding state sequence which satisfies the criteria for a successful state sequence with state machine 400. Some or all such multiple trials may each include respective processing stages which are each to variously determine a next state to include in the corresponding state sequence. Graph 500 also shows a range axis 512 representing reward values which are each associated with a corresponding one of the multiple trials. A reward for a given trial may represent, for example, a normalized (unitless) value which is a function of both a total number of states of the corresponding state sequence and a reward/penalty result associated with the corresponding state sequence. As shown in graph 500, significant improvements in the reward values begin to appear at about the twentieth trial, where at least some very efficient state sequence has been identified by around the sixtieth trial.

Similar to graph 500, graph 520 shows a domain axis 530 representing multiple trials in the order they were performed (e.g., the same trials as those represented by axis 510). Graph 520 also shows a range axis 532 representing the respective lengths (in total number of states) of the corresponding state sequences for each such trial. As shown in graph 520, the lengths of state sequences is quickly limited to not more than eight states, and reaches an optimal length (in this example, a length of six states) by around the sixtieth trial. The results shown by graphs 500, 520 are a significant improvement over techniques which are used conventionally in other types of neural network learning.

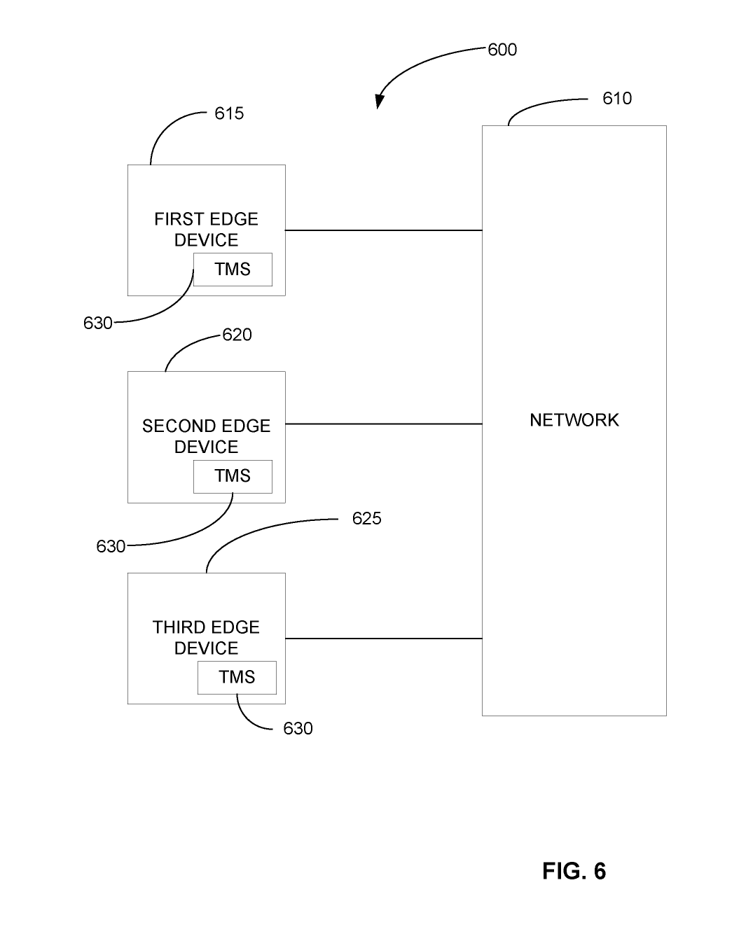

FIG. 6 is a block diagram of an example computer system 600 including a computer network 610 coupled to example first, second, and third edge devices 615, 620, 625, that each include an example thermal management system 630. The thermal management systems 630 are implemented using the spiking neural network technology disclosed herein.

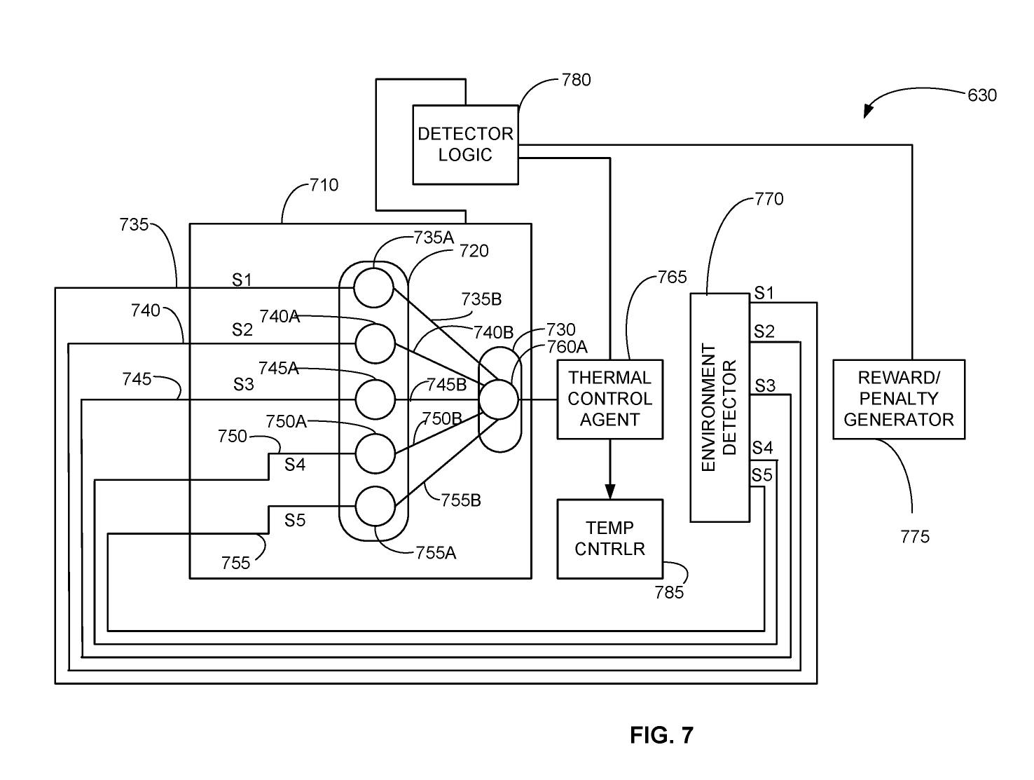

FIG. 7 is a block diagram of an example implementation of the example thermal management system 630 of FIG. 6. The thermal management system 630 of the example includes a spiking neural network 710 having an input layer 720 of neurons and an output layer 730 of neurons, five inputs (including a first input 735, a second input 740, a third input 745, a fourth input 750, and a fifth input 755), an example output 760, an example thermal control agent 765, an example environment detector 770, an example reward/penalty generator 775, an example detector logic 780, and an example temperature controller 785. In some examples, the input layer of the spiking neural network 710 includes a first input neuron 735A coupled to the first input 735, a second input neuron 740A coupled to the second input 740, a third input neuron 745A coupled to the third input 745, a fourth input neuron 750A coupled to the fourth input 750A, and a fifth input neuron 755A coupled to the fifth input 755. The output layer 730 of the spiking neural network 710 includes an example output neuron 760A coupled to the output 760. In some examples, the first, second, third, fourth, and fifth input neurons 735A, 740A, 745A, 750A, and 755A, are coupled to the output neuron 760A via example an example first synapse 735B, an example second synapse 740B, an example third synapse 745B, an example fourth synapse 750B, and example fifth synapse 755B, respectively. In some examples, the spiking neural network is implemented using a neuromorphic chip such as the Intel Loihi neuromorphic self learning chip.

In some examples, the example first, second, third, fourth and fifth input neurons 735A, 740A, 745A, 750A, and 755A are coupled to receive state variables representative of conditions of the environment. In some examples, the state variables represent temperature information and workload information that is captured by the environment detector 770. In some examples, the state variables include an example first state variable S1, an example second state variable S2, an example third state variable S3, an example fourth state variable S4, and an example fifth state variable S5. In some such examples, the first state variable S1 represents scheduled (workload) tasks stacked in a job queue of the device being thermally managed that are yet to be completed by the device. The first state variable S1 is provided to the first input neuron 735A. The second state variable S2 represents an amount of workload that has been completed during a time interval (e.g., 10 s, 1 min, etc.). The time interval depends on, for example, the system architecture and thermal management requirements. The second state variable S2 is provided to the second input neuron 740A. In some examples, the environment detector 770 obtains the first and second state variables S1 and S2 from an operating system of the device being thermally managed and/or from a CPU controller of the device being thermally managed. The third state variable S3 represents a temperature (to be controlled) of a surface of the electronic device that is being thermally managed and the third state variable S3 is provided to the third input neuron 745A. The fourth state variable S4 represents an amount of positive change in the surface temperature (S4 represents an amount by which the surface temperature increased) and is provided to the fourth input neuron 750A. The fifth state variable S5 represents an amount of negative change in the surface temperature (S5 represents an amount by which the surface temperature decreased) and is provided to the fifth input neuron 755A. In some examples, the third, fourth, and fifth state variables, S3, S4, and S5 are obtained by the environment detector 770 from a BIOS of the device being thermally managed, from board sensor mems readers of the device being thermally managed, from a driver counter of the device being thermally managed, etc. The state variables S1, S2, S3, S4 and S5 are illustrated in FIG. 7 as being output by the environment detector 770 and also being input to the spiking neural network 710.

In some examples, example first, second, third, fourth and fifth input spiking trains, δ1, δ2, δ3, δ4, δ5, are determined based on a corresponding one of the first, second, third, fourth and fifth state variables S1, S2, S3, S4, S5. In some examples, the input spiking trains are defined over a decision time window, T, and are determined based on

$$δ i ( t ) = ( rnd ( t ) < 1 - exp ( - \frac{{s}_{i}}{{α}_{i}} ) ) \qquad Eq ( 14 )$$

where “md(t)” is a random number drawn uniformly from the interval (0,1) at time t and αᵢ is a constant scaling parameter. In some examples, the value of α₁ is set equal to 100, the value of α₂ is set equal to 10, the value of α₃ is set equal to 60, α₄ is set equal to 2, and the value of α₄ is set equal to 2. In some examples, the value of T is set equal to 20.

The state variables S1, S2, S3, S4 and S5 are conveyed by the first, second, third, fourth and fifth input neurons 735A, 740A, 745A, 750A, 755A, to the output neuron 760A via the first, second, third, fourth, and fifth synapses 735B, 740B, 745B, 750B, and 755B, respectively. In some examples, the output neuron 760A obeys an-integrate-and-fire model which includes accumulating spiking activity from the first, second, third, fourth, and fifth input neurons 535A, 540A, 545A, 550A, 555A, and firing when the amount of spiking activity achieves a firing threshold.

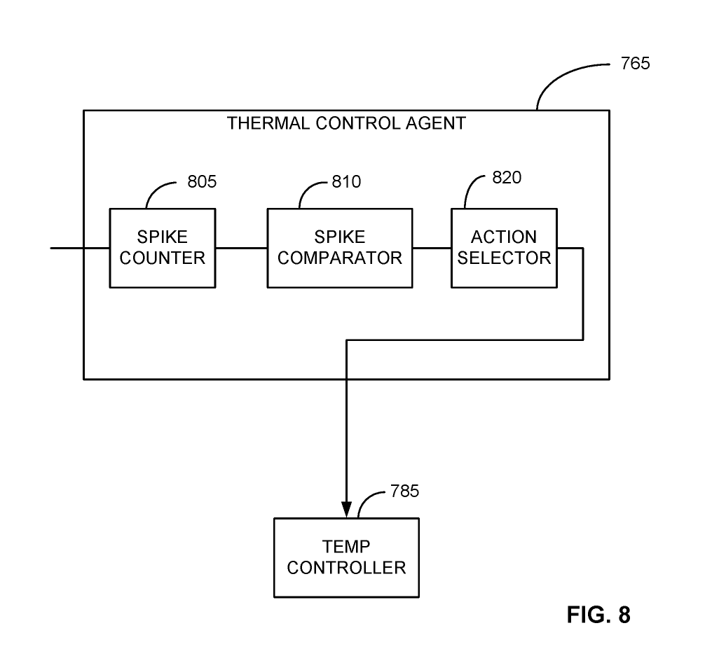

FIG. 8 is a block diagram of an example implementation of the example thermal control agent 765 of FIG. 7. The thermal control agent 765 includes an example spike counter 805, an example spike comparator 810, and an example action selector 820. In some examples, the spike counter 805 counts the spikes occurring at the output neuron 760A. In some such examples, the spike counter 805 supplies a number representing the count of the spikes occurring during a decision window T to the spike comparator 810. Using “q” to represent the number of spikes, “L” as a lower threshold and “H” as a higher threshold, the spike comparator 810 generates a decision, d, according to the following:

$$d = \{ \begin{matrix}- 1 , & if q < L \\ + 1 , & if q > H \\ 0 , & otherwise\end{matrix} \qquad Eq ( 15 )$$

In some examples, the goal of the thermal management system is to keep the temperature of the surface (of the device being thermally managed) below a surface temperature threshold while also keeping the workload below a workload threshold. In some examples, the surface temperature threshold is set at 60 degrees Celsius. However, any other temperature may be used (e.g., a temperature identified in a user manual for the device). In some examples, workload threshold is set at 100. The the workload threshold can be set at any desired value. In some examples, the workload threshold can be set to a desired number of gigaflops to be executed within a desired time frame or it can be set to a desired amount of time needed to finish a desired number of jobs in a workload queue.

The example action selector 820 selects one of several actions based on the decision, d, and supplies the selected action to the example temperature controller 785. The temperature controller 785 responds by taking the selected action. In some examples, the action selector 820 causes the temperature controller 785 to take any of three actions, a, including: 1) decreasing the surface temperature of the device being thermally managed by changing (e.g., decreasing) a workload of a CPU of the device being thermally managed (a=−P mW), 2) doing nothing (a=0 mW), or 3) increasing the surface temperature of the device being thermally managed by changing (e.g., increasing) the workload of the CPU (a=+P mW). In some examples, the value of P is set to be equal to an amount of power (in milliwatts) that will result in a one degree Celsius change in the surface temperature of the device being thermally managed. The value of P can be set to an amount of power needed to effect any amount of desired surface temperature change. In this example, the surface temperature is not directly modulated, but responds monotonically to changes in the workload of the device being thermally managed. As such, changes to the amount of workload power are used to control the surface temperature. Thus, the temperature controller 785 is actually adjusting the workload of the device being thermally managed to indirectly adjust the temperature.

The thermal control agent 765 can be configured to operate (e.g., take any of the three actions) in any number of different ways to respond to the decision, d, including the following two examples:

$$\begin{matrix}a = \{ \begin{matrix}- P mW , & if d = 0 \\ 0 mW , & if d = 1 \\ + P mW , & if d = - 1\end{matrix} & Eq ( 16 ) \\ a = \{ \begin{matrix}- P mW , & if d = 1 \\ 0 mW , & if d = 0 \\ + P mW , & if d = - 1\end{matrix} & Eq ( 17 )\end{matrix}$$

As discussed above, in these examples, the variable P represents an amount of power (in milliwatts) needed to change the temperature of the CPU by one degree Celsius (e.g., P=10). The thermal control agent 765 adjusts the workload of the CPU being thermally managed by causing the example temperature controller 785 to change the workload (which results in a temperature change).

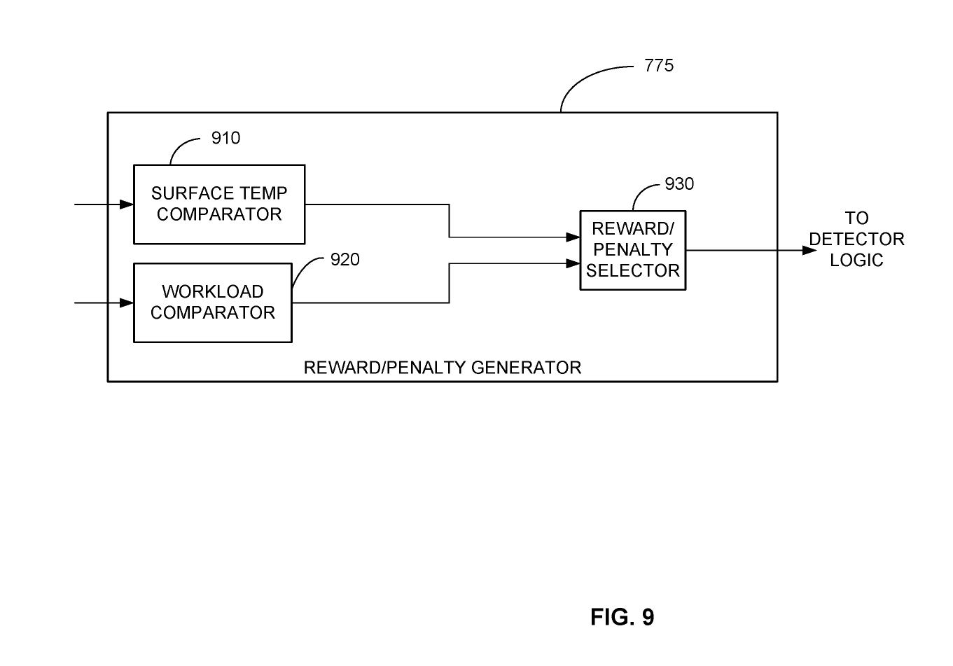

FIG. 9 is a block diagram of an example implementation of the example reward/penalty generator 775 of FIG. 7. In some examples, the reward/penalty generator 775 includes an example surface temperature comparator 910, an example workload comparator 920, and an example reward/penalty selector 930. In some examples, when either or both of the surface temperature and the workload limit reach the surface temperature threshold and workload threshold, respectively, (as indicated by the surface temperature comparator 910, and the workload comparator 920), the example reward/penalty selector 930 selects a penalty (also referred to as a negative reward) having a value of −1. In some examples, the penalty/negative reward is supplied to the example detector logic 780.

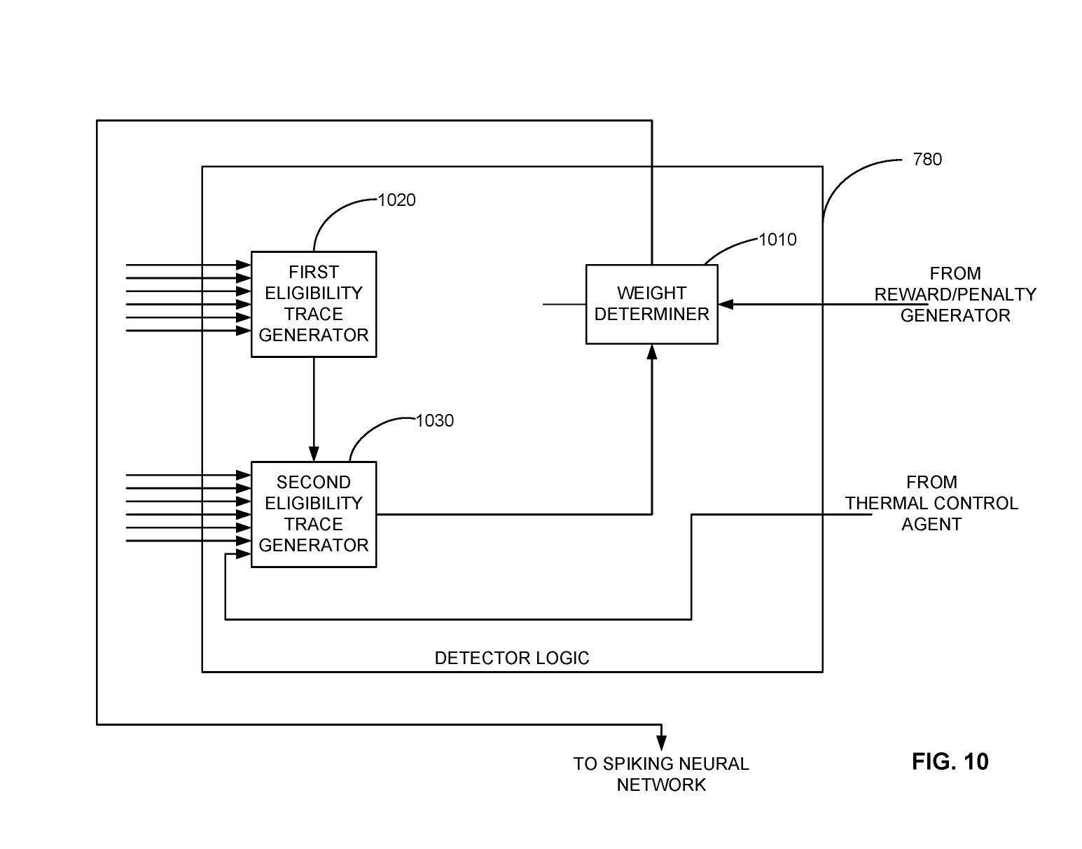

FIG. 10 is a block diagram of an example implementation of the example logic detector 780 of FIG. 7. In the example illustration of FIG. 10, the logic detector 780 includes an example weight determiner 1010, an example first eligibility trace generator 1020, and an example second eligibility trace generator 1030. In some examples, the weight determiner 1010 uses the penalty of −1 (in addition to other parameters) to determine an example first weight, w1, an example second weight, w2, an example third weight, w3, an example fourth weight, w4, and an example fifth weight, w5. In some examples, the signals supplied to the output neuron 755A via the first, second, third, fourth, and fifth synapses, 735B, 740B, 745B, 750B, and 755B, are multiplied by the first weight w1, the second weight w2, the third weight w3, the fourth weight w4, and the fifth weight w5, respectively.

In some examples, the example weight determiner 1010 of the example detector logic 780 determines the weights, w1, w2, w3, w4 and w5 based on an example first eligibility trace, eᵢ1 (generated by the example first eligibility trace generator 1020), an example second eligibility trace, eᵢ2 (generated by the example second eligibility trace generator 1030), and the penalty (the negative reward, r) generated by the penalty/reward generator 775 (see FIG. 7 and FIG. 9). In some examples, a set of first and second eligibility traces, eᵢ1 and eᵢ2, are generated for each of the first, second, third, fourth, and fifth input neurons 735A, 740A, 745A, 750A, and 755A. In some examples, the values for the first and second eligibility traces, eᵢ1 and eᵢ2, and for the weights, w1, w2, w3, w4, and w5, based on the following:

eᵢ1(t)=(1−ε₁)eᵢ1(t−1)+δᵢ(t) Eq(18)

eᵢ2(t)=(1−ε₂)eᵢ2(t−1)+eᵢ1(t)d Eq(19)

wᵢ(t)=wᵢ(t−1)+βeᵢ2(t)r Eq(20)

where wᵢ corresponds to the connecting weight of the i^{th} input neuron, ε₁ and ε₂ correspond to first and second decay parameters, δᵢ(t) corresponds to the spike signal coming from the i^{th} input neuron at time t (0 or 1), d is the acting decision, d (−1, 0, or +1), generated by the thermal control agent 765, β corresponds to a learning rate, and r corresponds to the penalty (negative reward). In some examples, the first and second decay parameters, ε₁ and ε₂, are set equal to values of ⅛ and 1, respectively. In some examples, the learning rate, β, is set equal to a value of 1. In some examples, the value of L is set equal to 5 and the value of H is set equal to 10. Based on a simulation, the values of the first and second decay parameters, ε₁ and ε₂, are set equal to ⅛ and 1, respectively. However, the values of the first and second decay parameters are implementation dependent in that they depend on the device in which the thermal management system is used and the characteristics of a neuromorphic chip used to implement the spiking neural network. In general, the values used for the first and second decay parameters are such that the value of the first decay parameter, ε₁, is much less than the value of the second decay parameter, ε₂. In addition, the value of L is less than the value of H.

Thus, the example weights, w1, w2, w3, w4, and w5, that are generated after each window of time, T, are affected by the most recently determined decision, d, of the thermal control agent 765, the eligibility traces eᵢ1 and eᵢ2, and the penalty, r. In some examples, the example detector logic 780 supplies the weights, w1, w2, w3, w4, and w5, to the corresponding synapses for application thereat. In some examples, the weights represent connection strengths between two nodes and are stored in a weight memory associated with the spiking neural network. As such, the weights (w1, w2, w3, w4, and w5) reflect, at least in part, whether previous actions taken by the example thermal control agent 765 are successful or unsuccessful in maintaining the surface temperature below the surface temperature threshold and maintaining the workload of the computer below the workload threshold. Further, as described above, signals traveling on the first, second, third, fourth, fifth and sixth synapses 735B, 740B, 745B, 750B, 755B, are multiplied by the first, second, third, fourth, and fifth weights, respectively, which, in turn, causes the signals to have greater (or lesser) impact on the firing of the output neuron 760.

While an example manner of implementing the example thermal management system 630 of FIG. 6 is illustrated in FIG. 7, FIG. 8, FIG. 9, and FIG. 10, one or more of the elements, processes and/or devices illustrated in FIGS. 7, 8, 9 and/or 10 may be combined, divided, re-arranged, omitted, eliminated and/or implemented in any other way. Further, the example thermal control agent 765, the example temperature controller 785, the example environment detector 770, the example reward/penalty generator 775, the example detector logic 780, the example spike counter 805, the example spike comparator 810, the example action selector 820, the example surface temperature comparator 910, the example workload comparator 920, the example reward/penalty selector 930, the example weight determiner 1010, the example first eligibility trace generator 1020, the example second eligibility trace generator 1030, and/or, more generally, the example thermal management system 630 of FIG. 6 may be implemented by hardware, software, firmware and/or any combination of hardware, software and/or firmware. Thus, for example, any of the example thermal control agent 765, the example temperature controller 785, the example environment detector 770, the example reward/penalty generator 775, the example detector logic 780, the example spike counter 805, the example spike comparator 810, the example action selector 820, the example surface temperature comparator 910, the example workload comparator 920, the example reward/penalty selector 930, the example weight determiner 1010, the example first eligibility trace generator 1020, the example second eligibility trace generator 1030, and/or, more generally, the example thermal management system 630 of FIG. 6 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example thermal control agent 765, the example temperature controller 785, the example environment detector 770, the example reward/penalty generator 775, the example detector logic 780, the example spike counter 805, the example spike comparator 810, the example action selector 820, the example surface temperature comparator 910, the example workload comparator 920, the example reward/penalty selector 930, the example weight determiner 1010, the example first eligibility trace generator 1020, the example second eligibility trace generator 1030, and/or the example thermal management system 630 of FIG. 6 is/are hereby expressly defined to include a non-transitory computer readable storage device or storage disk such as a memory, a digital versatile disk (DVD), a compact disk (CD), a Blu-ray disk, etc. including the software and/or firmware. Further still, the example thermal management system 630 of FIG. 6 may include one or more elements, processes and/or devices in addition to, or instead of, those illustrated in FIGS. 7-10, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

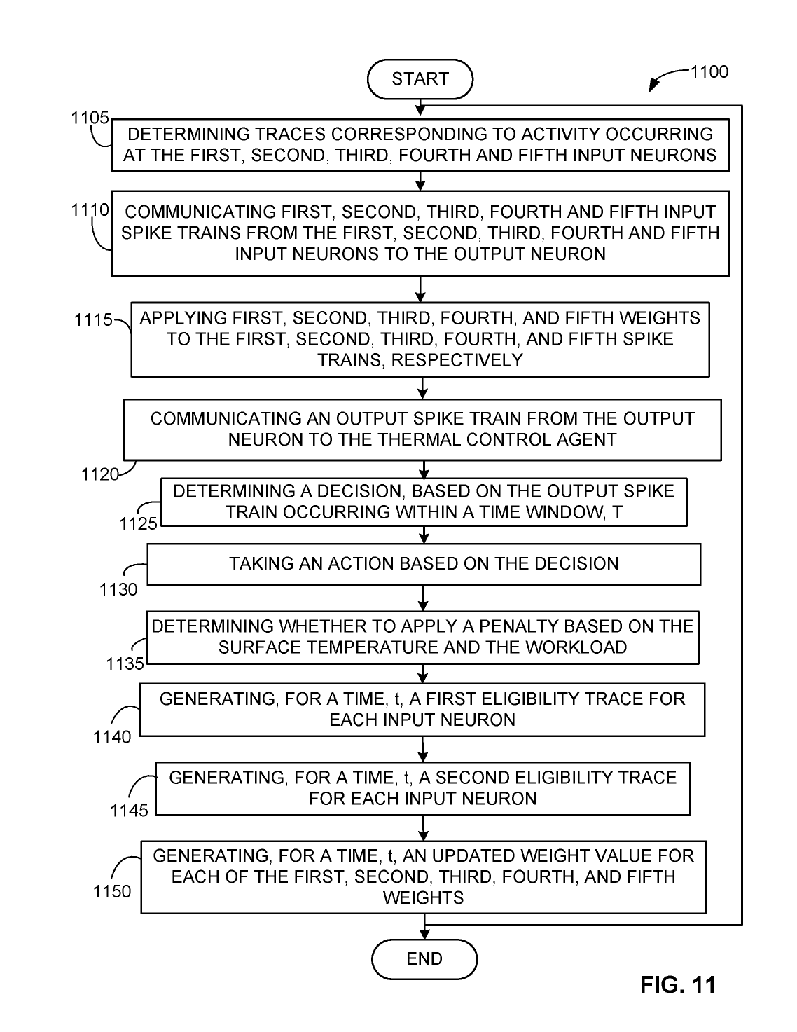

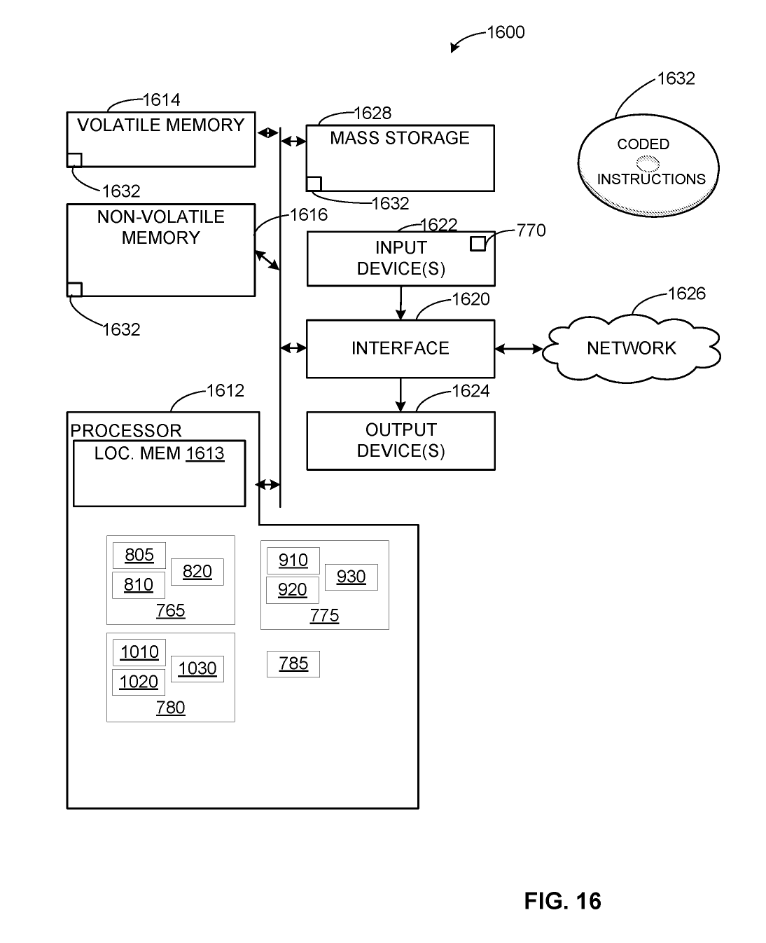

Flowcharts representative of example hardware logic, machine readable instructions, hardware implemented state machines, and/or any combination thereof for implementing the thermal management system 630 of FIG. 6 are shown in FIGS. 11-15. The machine readable instructions may be executable programs or portions of executable programs for execution by a computer processor such as the processor 1612 shown in the example processor platform 1600 discussed below in connection with FIG. 16. The programs may be embodied in software stored on a non-transitory computer readable storage medium such as a CD-ROM, a floppy disk, a hard drive, a DVD, a Blu-ray disk, or a memory associated with the processor 1612, but the entire programs and/or parts thereof could alternatively be executed by a device other than the processor 1612 and/or embodied in firmware or dedicated hardware. Further, although the example programs are described with reference to the flowcharts illustrated in FIGS. 11, 12, 13 and 14, many other methods of implementing the example thermal management system 630 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 11, 12, 13, 14 and 15, may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The program 1100 of FIG. 11 begins at a block 1105 at which input spike trains representing the signal activity occurring at the each of the first, second, third, fourth and fifth input neurons are determined. In some examples, the input spike trains are generated (based on equation 14) using circuitry separate from the detector logic 780 and the spiking neural network In addition, input spike trains are communicated from the first, second, third, fourth, fifth and sixth input neurons to the output neuron via the first, second, third, fourth, fifth and sixth synapses, respectively (block 1110). While in transmission, the spike trains communicated via the synapses, are weighted by the first, second, third, fourth and fifth, weights (generated by the example weight determiner 1010), respectively (block 1115). A synapse between two neurons and the weight assigned to the synapse represents the strength of the connection. When a spike arrives at a neuron, a stronger connection will cause the neuron receiving the spike to respond more than a weaker connection will cause the neuron to respond. An output spike train is communicated from the output neuron to the example thermal control agent 765 (block 1120). The example spike counter 805, spike comparator 810, and action selector 820 of the example thermal control agent 765 generates a decision, d, based on the output spike train (block 1125) and further takes an action based on the decision (block 1130). The action includes one of 1) doing nothing, 2) increasing the temperature of the computer processing unit by increasing the workload, or 3) decreasing the temperature of the computer processing unit by decreasing the workload.

In some examples, the example reward/penalty generator 775 determines whether to apply a penalty (or negative reward) of −1 based on whether the surface temperature has reached a threshold (based on the surface temperature comparator 910, and whether the workload has reached a threshold (based on the workload comparator 920) (block 1135). Depending on the output of the surface temperature comparator 910 and the output of the workload comparator 920, the reward/penalty selector 930 selects a penalty (negative reward) to be supplied to the example detector logic 780 (see FIG. & and FIG. 10) (also at block 1135).

In some examples, the example first eligibility trace generator 1020 generates a first eligibility trace for each of the first, second, third, fourth, and fifth input neurons (block 1140). In addition, the example second eligibility trace generator 1030 generates a second eligibility trace for each of the first, second, third, fourth, and fifth the input neurons (block 1145). The example weight determiner 1010 determines an updated weight value for each of the first, second, third, fourth, and fifth weights (block 1150). Thereafter, the program returns to the block 1105 and the blocks subsequent thereto as described above.

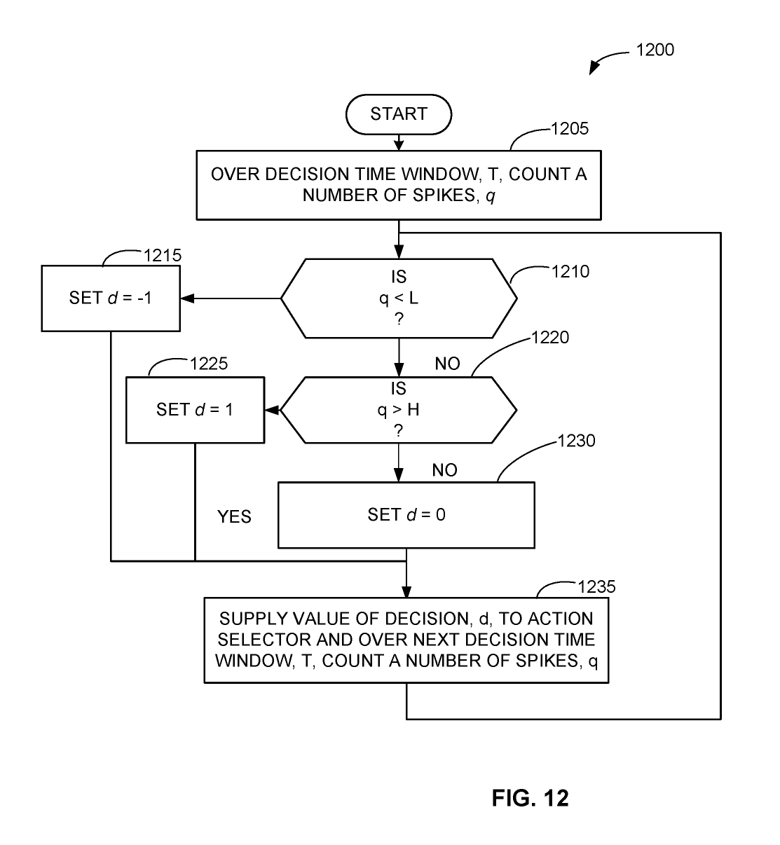

The program 1200 of FIG. 12 can be used to implement the example thermal control agent 765 of FIG. 8. In some examples, the program 1200 begins at a block begins at a block 1205 at which the example spike counter 805 (see FIG. 8) counts a number of spikes occurring at the output neuron over a decision time window, T. The example spike comparator 810 compares the number of spikes counted by the spike counter 805 to a lower spike threshold, L, (block 1210) and, when the number of spikes, q, is less than the lower spike threshold, L, the spike comparator 810 outputs a decision value, d, that is equal to −1 (block 1215). When the number of spikes, q, is not less than the lower spike threshold, L, the example spike comparator 810 compares the number of counted spikes q to a higher spike threshold, H, (block 1220). When the number of spikes, q, is greater than the upper spike threshold, H, the spike comparator 810 outputs a decision value, d, that is equal to 1 (block 1225). When the number of spikes, q, is not greater than the upper spike threshold, H, the example spike comparator 810 outputs a decision value, d, that is equal to 0 (block 1230). After generating the decision value, d, (see any of blocks 1215, 1225 and 1230), the example spike comparator 810 supplies the value of the decision, d, to the example action selector 820 and the spike counter 805 begins counting spikes at the output neuron over a next decision time window (block 1235) and the program 1200 returns to the block 1210 and the blocks subsequent thereto as described above.

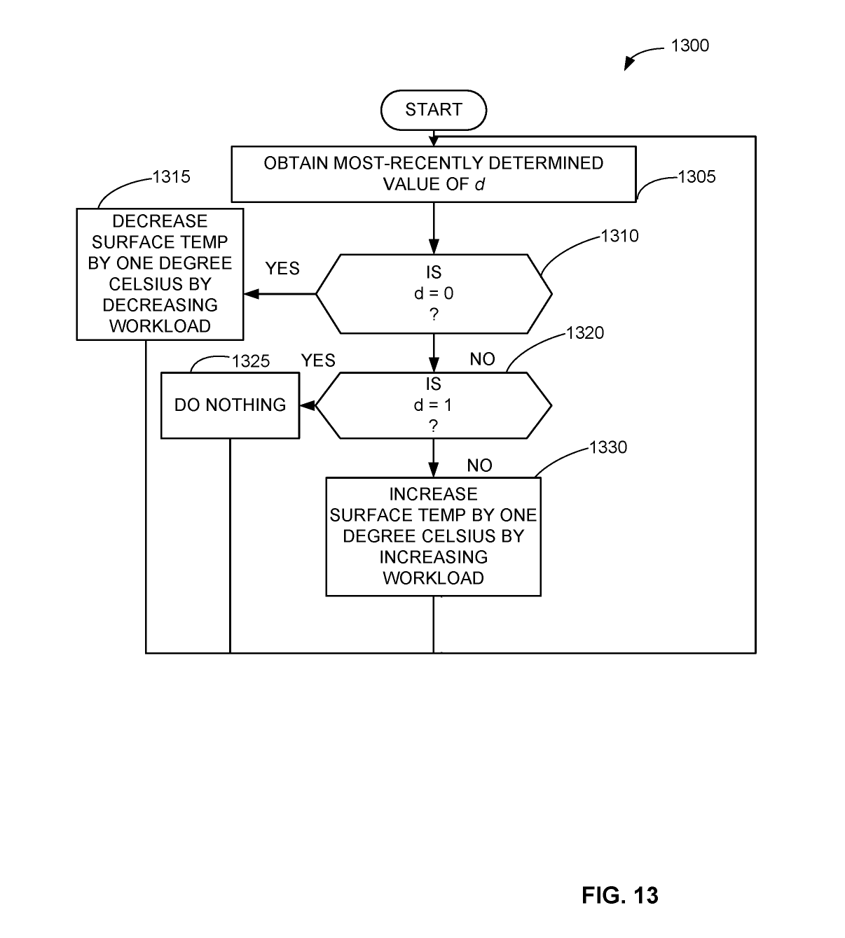

The program 1300 of FIG. 13 can be used to implement the example action selector 820 of the example thermal control agent 765 of FIG. 8. In some examples, the program 1300 begins at a block 1305 at which the example action selector 820 receives and/or obtains the most recently determined value of the decision, d. The action selector 820 determines whether the decision, d, is equal to 0 (block 1310). If the value of d is equal to 0, the action selector 820 selects an action, a, to decrease the surface temperature of the device being thermally managed by one degree Celsius by decreasing the workload by “−P” (block 1315). In some such examples, the action selector 820 causes the example temperature controller 785 to decrease the workload by −P mW (also at block 1315). If the value of the decision, d, is not equal to 0, the action selector 820 determines whether the decision, d, is equal to 1 (block 1320). If the value of the decision, d, is equal to 1, the action selector 820 selects an action to do nothing to change the surface temperature of the device being thermally managed (block 1325). If the value of d is not equal to either 0 or 1, the value of d (by default) is equal to a −1. As a result, the action selector 820 selects an action, a, to increase the surface temperature of the device being thermally managed by one degree Celsius (block 1330). In some such examples, the action selector 820 causes the temperature controller 785 to increase the workload by P mW (also at the block 1330). After the action, a, has been taken, the program returns to the block 1305 and blocks subsequent thereto as described above.

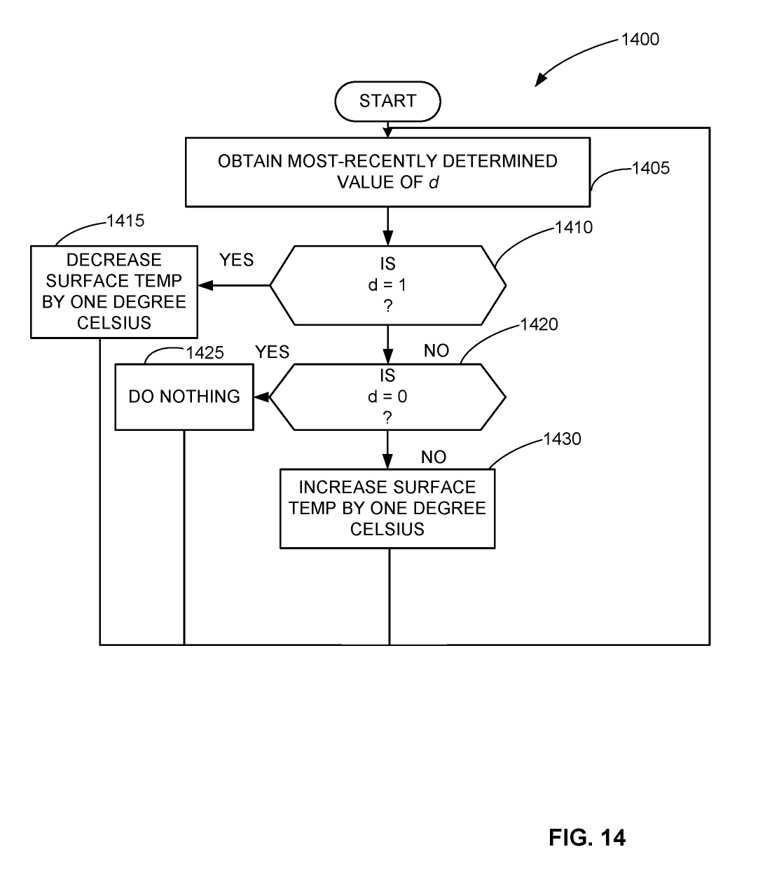

The program 1400 of FIG. 14 can be used to implement the example action selector 820 of the example thermal control agent 765 of FIG. 8. In some examples, the program 1400 begins at a block 1405 at which the example action selector 820 receives and/or obtains the most recently determined value of the decision, d. The action selector 820 determines whether the decision, d, is equal to 1 (block 1410). If the value of d is equal to 1, the action selector 820 selects an action, a, to decrease the temperature of the surface of the device being thermally managed by one degree Celsius by causing the temperature controller 785 to decrease the workload by −P mW (block 1415). If the value of the decision, d, is not equal to 1, the action selector 820 determines whether the decision, d, is equal to 0 (block 1420). If the value of the decision, d, is equal to 0, the action selector 820 selects an action, a, to not change the temperature of the device being thermally managed (block 1425). If the value of the decision, d, is not equal to either 0 or 1, the value of the decision, d (by default), is equal to a −1. As a result, the action selector 820 selects an action, a, to increase the temperature of the surface of the device being thermally managed. In some such examples, the action selector 820 causes the temperature controller 785 to increase the temperature by one degree Celsius by increasing the workload by P mW (block 1430). After the action has been taken, the program returns to the block 1405 and blocks subsequent thereto as described above.

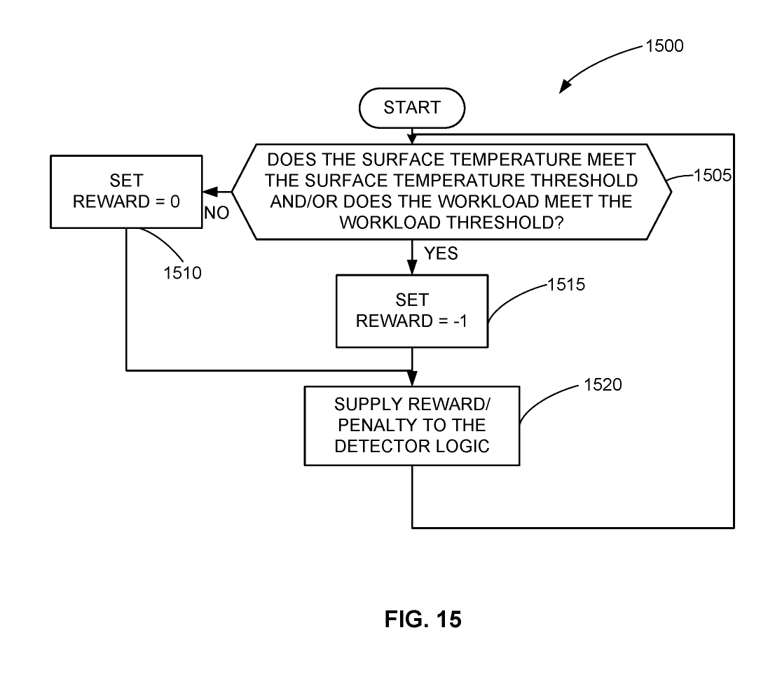

The program 1500 of FIG. 15 can be used to implement the example reward/penalty generator 775 of the example thermal management system of FIG. 7. In some examples, the program 1500 begins at a block 1505 at which the example surface temperature comparator 910 compares a surface temperature of the example computing device to a surface temperature threshold and the example workload comparator 920 compares the workload to a workload threshold. In some examples, the thermal temperature comparator 910 obtains the temperature from BIOS, board sensor mems readers, a driver counter, etc. In some examples, the workload comparator 920 obtains the workload from an operating system of the device being thermally managed or from a CPU controller of the device being thermally managed. When either threshold is met/satisfied, the reward/penalty selector 930 selects a penalty (and/or a negative reward) of −1 (block 1515) and supplies the penalty of −1 to the example detector logic 780 (block 1520). When neither threshold is met/satisfied, the reward/penalty selector 930 selects a penalty (and/or negative reward) of 0 (block 1510) and supplies the penalty of 0 to the example detector logic 780 (block 1520). After the penalty/reward is supplied to the example detector logic 780, the program 1500 returns to the block 1505 and the blocks subsequent thereto.

FIG. 16 is a block diagram of an example processor platform 1600 structured to execute the instructions of FIGS. 11, 12, 13 and 14 to implement the thermal management system of FIG. 7. The processor platform 1600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 1600 of the illustrated example includes a processor 1612. The processor 1612 of the illustrated example is hardware. For example, the processor 1612 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example thermal controller agent 765, the temperature controller 785, the example reward, penalty generator 775, the example detector logic 780, the example spike counter 805, the example spike comparator 810, the example action selector 820, the example surface temperature comparator 910, the example workload comparator 920, the example reward/penalty selector 930, the example weight determiner 1010, the example first eligibility trace generator 1020, and the example second eligibility trace generator 1030.

The processor 1612 of the illustrated example includes a local memory 1613 (e.g., a cache). The processor 1612 of the illustrated example is in communication with a main memory including a volatile memory 1614 and a non-volatile memory 1616 via a bus 1618. The volatile memory 1614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1616 may be implemented by flash memory and/or any other desired type of memory device. Access to the main memory 1614, 1616 is controlled by a memory controller.

The processor platform 1600 of the illustrated example also includes an interface circuit 1620. The interface circuit 1620 may be implemented by any type of interface standard, such as an Ethernet interface, a universal serial bus (USB), a Bluetooth® interface, a near field communication (NFC) interface, and/or a PCI express interface.

In the illustrated example, one or more input devices 1622 are connected to the interface circuit 1620. The input device(s) 1622 permit(s) a user to enter data and/or commands into the processor 1612. The input device(s) can be implemented by, for example, an audio sensor, a microphone, a camera (still or video), a keyboard, a button, a mouse, a touchscreen, a track-pad, a trackball, isopoint and/or a voice recognition system. The input device(s) 1622 can be used to implement the example environment detector 770.

One or more output devices 1624 are also connected to the interface circuit 1620 of the illustrated example. The output devices 1624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1620 of the illustrated example, thus, typically includes a graphics driver card, a graphics driver chip and/or a graphics driver processor.

The interface circuit 1620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1626. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1600 of the illustrated example also includes one or more mass storage devices 1628 for storing software and/or data. Examples of such mass storage devices 1628 include floppy disk drives, hard drive disks, compact disk drives, Blu-ray disk drives, redundant array of independent disks (RAID) systems, and digital versatile disk (DVD) drives.

The machine executable instructions 1632 of FIGS. 11-14 may be stored in the mass storage device 1628, in the volatile memory 1614, in the non-volatile memory 1616, and/or on a removable non-transitory computer readable storage medium such as a CD or DVD.

From the foregoing, it will be appreciated that example methods, apparatus and articles of manufacture have been disclosed that use spiking neural network technology to perform thermal management of a computer device. Additionally, example methods, systems, apparatus and articles of manufacture disclosed herein perform thermal management of a computer device without any prior knowledge of the temperature characteristics of the device. Additionally, thermal management systems disclosed herein consume very little power (at the nano-Watt level), and, thus, have negligible impact on the battery life of any batteries used to power the system. The disclosed methods, apparatus and articles of manufacture disclosed herein are accordingly directed to one or more improvement(s) in the functioning of a computer.

Simulations performed on a Matlab simulator demonstrated the effectiveness of a thermal management device in accordance with the technologies of this disclosure in controlling surface temperature and workload using the equations of 16 and equation 17. In both instances, after learning through a few hundred decision periods, the spiking neural network was able to control both the surface temperature and the workload within desired ranges. In addition, the simulations indicate that the thermal management system achieved the temperature and workload control while consuming energy at the nano-Watt level.

The following further examples are disclosed herein.

Example 1 is one or more non-transitory machine readable mediums comprising instructions that, when executed, cause at least one processor to at least, during a first time window, generate weights to be applied to input trains of spikes from input neurons of a spiking neural network. In Example 1, the input neurons receive temperature information and workload information from the processor. The instructions of Example further cause the at least one processor to, based on a number of spikes included in an output train of spikes output by an output neuron of the spiking neural network during the first time window, adjust the workload of the at least one processor. The instructions also cause the at least one processor to, based on whether a surface temperature of an enclosure housing the processor meets a first threshold or a workload of the processor meets a second threshold, generate a penalty, and, train the spiking neural network by updating the weights during a second time window. In Example 1, the weights are updated based on the number of spikes included in the output train of spikes, and the penalty.

Example 2 includes the one or more non-transitory machine readable mediums of Example 1. In Example 2, the instructions cause the at least one processor to train the spiking neural network by generating a first eligibility trace and a second eligibility trace. The first eligibility trace affects the second eligibility trace, and the second eligibility trace affects the impact that the penalty has on the updated weights.

Example 3 includes the one or more non-transitory machine readable mediums of Example 2. In Example 3, the first eligibility trace is based on the input trains of spikes and a decay parameter.

Example 4 includes the one or more non-transitory machine readable mediums of Example 2. In Example 4, the second eligibility trace is based on a second decay parameter and the number of spikes included in the output train of spikes.

Example 5 includes the one or more non-transitory machine readable mediums of Example 2. In Example 5, the instructions cause the at least one processor to update the weights by multiplying the penalty by a learning rate and the second eligibility trace.

Example 6 includes the one or more non-transitory machine readable mediums of Example 1. In Example 6, the instructions to cause the at least one processor to adjust the workload cause the at least one processor to change a surface temperature of an enclosure housing the processor by the adjusting of the workload.

Example 7 includes the one or more non-transitory machine readable mediums of Example 6. In Example 6, the instructions cause the at least one processor to change the workload of the processor by counting the number of spikes included in the output train of spikes during the first window of time, comparing the number of spikes included in the output train of spikes to a lower threshold and an upper threshold. In Example 7, the instructions further the at least one processor to change the workload of the processor by, when the number of spikes is less than the lower threshold, increasing the workload of the processor, and, when the number of spikes is greater than the lower threshold, decreasing the workload of the processor.

Example 8 includes the one or more non-transitory machine readable mediums of Example 6. In Example 8, the input neurons include a first input neuron to receive a first workload value representing workload tasks in a job queue of the processor. In Example 8, the workload tasks in the job are yet to be completed. In Example 8, the input neurons also include a second input neuron to receive a second workload change representing an amount of workload completed within a time interval, a third input neuron to receive a surface temperature of the enclosure housing the processor, and a fourth input neuron and a fifth input neuron. In Example 9, the fourth and fifth input neurons receive an amount of positive changes in the surface temperature and an amount of negative changes in the surface temperature, respectively.

Example 9 is a thermal management system to thermally manage a processor that includes a spiking neural network. The spiking neural network includes input neurons and at least one output neuron. In Example 9, the input neurons receive temperature information and workload information from the processor being thermally managed. The thermal management system of Example 9 also includes a thermal control agent to adjust a workload of the processor based on a number of spikes included in an output train of spikes output by the output neuron during a first window of time, a reward/penalty generator to generate a penalty, based on whether a surface temperature of a housing of the processor meets a first threshold or a workload of the processor meets a second threshold, and detector logic to generate weights. The weights are applied to input trains of spikes from the input neurons, the weights generated are based on the number of spikes included in the input train of spikes, and are based on the penalty.

Example 10 includes the thermal management system of Example 9. In Example 10, the detector logic is to generate a first eligibility trace and a second eligibility trace. The first eligibility trace affects the second eligibility trace, and the second eligibility trace affects the impact that the penalty has on the weights.

Example 11 includes the thermal management system of Example 10. In Example 11, the first eligibility trace is based on the input trains of spikes and on a decay parameter.

Example 12 includes the thermal management system of Example 11. In Example 12, the second eligibility trace is based on a second decay parameter, and the number of spikes included in the output train of spikes.

Example 13 includes the thermal management system of Example 10. In Example 13, the detector logic is to update the weights by multiplying the penalty by a learning rate and the second eligibility trace.

Example 14 includes the thermal management system of Example 9. In Example 14, the thermal control agent is to adjust the workload of the processor by counting the number of spikes included in the at least one output train of spikes during a first window of time, and comparing the number of spikes to a lower threshold and an upper threshold. When the number of spikes is less than the lower threshold, the thermal control agent increases the workload of the processor, and, when the number of spikes is greater than the lower threshold, the thermal control agent decreases the workload of the processor.

Example 15 includes the thermal management system of Example 9. In Example 15, the input neurons include a first input neuron to receive a first workload value representing workload tasks in a job queue of the processor that are not yet completed, a second input neuron to receive a second workload change representing an amount of workload completed within a time interval, a third input neuron to receive a surface temperature of the housing of the processor, and a fourth input neuron and a fifth input neuron. In Example 15, the fourth and fifth input neurons receive an amount of positive changes in the surface temperature and an amount of negative changes in the surface temperature, respectively.

Example 16 is a method for thermal management of a computing device that includes, during a first time window, weighting input trains of spikes from input neurons of a spiking neural network. The input neurons to receive temperature information and workload information from the computing device. The method also includes, based on a number of spikes included in an output train of spikes output by an output neuron of the spiking neural network during the first time window, adjusting, by executing an instruction with a processor of the computing device, the workload of the processor. The method of Example 16 further includes, based on whether a surface temperature of an enclosure of the computing device meets a first threshold or a workload of the computing device meets a second threshold, generating, by executing an instruction with a processor of the computing device, a penalty. The method of Example 16 still further includes training, by executing an instruction with a processor of the computing device, the spiking neural network by updating weights to be used for weighting the input trains of spikes during a second window of time. The training is based on the number of spikes included in the output train of spikes, and on the penalty.

Example 17 includes the method of Example 16. In Example 17, the training of the spiking neural network includes generating a first eligibility trace and a second eligibility trace. In Example 17, the first eligibility trace affects the second eligibility trace, and the second eligibility trace affects the impact that the penalty has when generating updated weights.

Example 18 includes the method of Example 17. In Example 18, the first eligibility trace is based on the input train of spikes and is further based on a decay parameter.

Example 19 includes the method of Example 18. In Example 19, the second eligibility trace is based on a second decay parameter and the number of spikes included in the output train of spikes.

Example 20 includes the method of Example 16. In Example 20, adjusting the workload of the computing device includes counting the number of spikes included in the output train of spikes during the first window of time, and comparing the number of spikes to a lower threshold and an upper threshold. The method of Example 20 further includes when the number of spikes is less than the lower threshold, increasing the workload of the processor, and, when the number of spikes is greater than the lower threshold, decreasing the workload of the processor.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. One or more non-transitory machine readable mediums comprising instructions that, when executed, cause at least one processor to at least:
during a first time window, generate weights to be applied to input trains of spikes from input neurons of a spiking neural network, the input neurons to receive temperature information and workload information from the processor;
based on a number of spikes included in an output train of spikes output by an output neuron of the spiking neural network during the first time window, adjust the workload of the at least one processor;
based on whether a surface temperature of an enclosure housing the processor meets a first threshold or a workload of the processor meets a second threshold, generate a penalty; and
train the spiking neural network by updating the weights during a second time window, the weights updated based on the number of spikes included in the output train of spikes, and the penalty.

2. The one or more non-transitory machine readable mediums of claim 1, wherein the instructions cause the at least one processor to train the spiking neural network by generating a first eligibility trace and a second eligibility trace, the first eligibility trace affecting the second eligibility trace, and the second eligibility trace affecting the impact that the penalty has on the updated weights.

3. The one or more non-transitory machine readable mediums of claim 2, wherein the first eligibility trace is based on the input trains of spikes and a decay parameter.

4. The one or more non-transitory machine readable mediums of claim 2, wherein the second eligibility trace is based on a second decay parameter and the number of spikes included in the output train of spikes.

5. The one or more non-transitory machine readable mediums of claim 2, wherein the instructions cause the at least one processor to update the weights by multiplying the penalty by a learning rate and the second eligibility trace.

6. The one or more non-transitory machine readable mediums of claim 1, wherein the instructions to cause the at least one processor to adjust the workload cause the at least one processor to change a surface temperature of an enclosure housing the processor by the adjusting of the workload.

7. The one or more non-transitory machine readable mediums of claim 6, wherein instructions cause the at least one processor to change the workload of the processor by:
counting the number of spikes included in the output train of spikes during the first window of time,
comparing the number of spikes included in the output train of spikes to a lower threshold and an upper threshold;
when the number of spikes is less than the lower threshold, increasing the workload of the processor; and
when the number of spikes is greater than the lower threshold, decreasing the workload of the processor.

8. The one or more non-transitory machine readable mediums of claim 6, wherein the input neurons include:
a first input neuron to receive a first workload value representing workload tasks in a job queue of the processor, the workload tasks in the job yet to be completed;
a second input neuron to receive a second workload change representing an amount of workload completed within a time interval;
a third input neuron to receive a surface temperature of the enclosure housing the processor; and
a fourth input neuron and a fifth input neuron, the fourth and fifth input neurons to receive an amount of positive changes in the surface temperature and an amount of negative changes in the surface temperature, respectively.

9. A thermal management system to thermally manage a processor, the system comprising:
a spiking neural network including input neurons and at least one output neuron, the input neurons to receive temperature information and workload information from the processor being thermally managed;
a thermal control agent to adjust a workload of the processor based on a number of spikes included in an output train of spikes output by the output neuron during a first window of time;
a reward/penalty generator to generate a penalty, based on whether a surface temperature of a housing of the processor meets a first threshold or a workload of the processor meets a second threshold; and
detector logic to generate weights, the weights applied to input trains of spikes from the input neurons, the weights generated based on the number of spikes included in the input train of spikes, and based on the penalty.

10. The thermal management system of claim 9, wherein the detector logic is to generate a first eligibility trace and a second eligibility trace, the first eligibility trace affecting the second eligibility trace, and the second eligibility trace affecting the impact that the penalty has on the weights.

11. The thermal management system of claim 10, wherein the first eligibility trace is based on the input trains of spikes and on a decay parameter.

12. The thermal management system of claim 11, wherein the second eligibility trace is based on a second decay parameter, and the number of spikes included in the output train of spikes.

13. The thermal management system of claim 10, wherein the detector logic is to update the weights by multiplying the penalty by a learning rate and the second eligibility trace.

14. The thermal management system of claim 9, wherein the thermal control agent is to adjust the workload of the processor by:
counting the number of spikes included in the at least one output train of spikes during a first window of time;
comparing the number of spikes to a lower threshold and an upper threshold;
when the number of spikes is less than the lower threshold, increasing the workload of the processor; and
when the number of spikes is greater than the lower threshold, decreasing the workload of the processor.

15. The thermal management system of claim 9, wherein the input neurons include:
a first input neuron to receive a first workload value representing workload tasks in a job queue of the processor, the workload tasks not yet completed;
a second input neuron to receive a second workload change representing an amount of workload completed within a time interval;
a third input neuron to receive a surface temperature of the housing of the processor; and
a fourth input neuron and a fifth input neuron, the fourth and fifth input neurons to receive an amount of positive changes in the surface temperature and an amount of negative changes in the surface temperature, respectively.

16. A method for thermal management of a computing device, the method comprising:
during a first time window, weighting input trains of spikes from input neurons of a spiking neural network, the input neurons to receive temperature information and workload information from the computing device;
based on a number of spikes included in an output train of spikes output by an output neuron of the spiking neural network during the first time window, adjusting, by executing an instruction with a processor of the computing device, the workload of the processor;
based on whether a surface temperature of an enclosure of the computing device meets a first threshold or a workload of the computing device meets a second threshold, generating, by executing an instruction with a processor of the computing device, a penalty; and
training, by executing an instruction with a processor of the computing device, the spiking neural network by updating weights to be used for weighting the input trains of spikes during a second window of time, the training based on the number of spikes included in the output train of spikes, and on the penalty.

17. The method of claim 16, wherein the training of the spiking neural network includes generating a first eligibility trace and a second eligibility trace, the first eligibility trace affecting the second eligibility trace, and the second eligibility trace affecting the impact that the penalty has when generating updated weights.

18. The method of claim 17, wherein the first eligibility trace is based on the input train of spikes and is further based on a decay parameter.

19. The method of claim 18, wherein the second eligibility trace is based on a second decay parameter and the number of spikes included in the output train of spikes.

20. The method of claim 16, wherein adjusting the workload of the computing device includes:
counting the number of spikes included in the output train of spikes during the first window of time;
comparing the number of spikes to a lower threshold and an upper threshold;
when the number of spikes is less than the lower threshold, increasing the workload of the processor; and
when the number of spikes is greater than the lower threshold, decreasing the workload of the processor.
